(19) United States
(12) Patent Application Publication
(10) Pub. No.: US 2025/0038818 A1
(43) Pub. Date: Jan. 30, 2025

(54) BEAM BASED COLLISION DETECTION WITH INTER-UE COORDINATION ON SIDELINK

(71) Applicant: QUALCOMM Incorporated, San Diego, CA (US)

(72) Inventors: Qing LI, Princeton Junction, NJ (US); Hong CHENG, Basking Ridge, NJ (US); Junyi LI, Greentown, PA (US)

(21) Appl. No.: 18/783,602

(22) Filed: Jul. 25, 2024

Related U.S. Application Data
(60) Provisional application No. 63/516,357, filed on Jul. 28, 2023.

(51) Int. Cl. H04B 7/06; H04L 1/1812; H04L 5/00; H04W 72/40; H04W 74/0808

(52) U.S. Cl. CPC H04B 7/0695; H04L 1/1812; H04L 5/0055; H04W 72/40; H04W 74/0825

(57) ABSTRACT

Wireless communications systems and methods related to sidelink communication between user equipments (UEs). A first UE transmits, to a second UE using a first transmit beam, sidelink control information (SCI) identifying a scheduled resource for a second message and a physical sidelink shared channel (PSSCH) message. The first UE receives, from the second UE using a first receive beam associated with the first transmit beam, an indication of a resource collision associated with the first UE, the second UE, and a third UE. The first UE and performing an action in response to the indication, wherein the action includes at least one of dropping the second message, or re-transmitting, to the second UE, the PSSCH message with the scheduled resource for the second message.

### CROSS-REFERENCE TO RELATED APPLICATIONS

The present application claims the benefit of, and priority to, U.S. Provisional Patent Application No. 63/516,357, filed Jul. 28, 2023, the entirety of which is incorporated by reference herein.

### TECHNICAL FIELD

This application relates to wireless communication systems, and more particularly to improving sidelink communication with New Radio (NR) devices.

### INTRODUCTION

Wireless communications systems are widely deployed to provide various types of communication content such as voice, video, packet data, messaging, broadcast, and so on. These systems may be capable of supporting communication with multiple users by sharing the available system resources (e.g., time, frequency, and power). A wireless multiple-access communications system may include a number of base stations (BSs), each simultaneously supporting communications for multiple communication devices, which may be otherwise known as user equipment (UE).

Sidelink was introduced to allow a UE to send data to another UE without tunneling through the BS and/or an associated core network. Sidelink technology has been extended to provision for device-to-device (D2D) communications, vehicle-to-everything (V2X) communications, and/or cellular vehicle-to-everything (C-V2X) communications. Similarly, NR may be extended to support sidelink communications for D2D, V2X, and/or C-V2X over a dedicated spectrum, a licensed spectrum, and/or an unlicensed spectrum.

UEs may transmit and receive signals using specific transmit or receive beams, for example by utilizing beamforming antenna arrays. Beamforming allows for more efficiency power utilization, and may help avoid interference with other devices. However, some existing systems rely on scheduling messages being broadcast in many directions so that scheduled resources are commonly known, and interference between devices may be avoided. Therefore, there is a need for systems and methods for beam based collision detection with inter-UE coordination on sidelink.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

For example, in an aspect of the disclosure, a method of wireless communication performed by a first user equipment (UE), the method comprising transmitting, to a second UE using a first transmit beam, sidelink control information (SCI) identifying a scheduled resource for a second message and a physical sidelink shared channel (PSSCH) message. The method further comprises receiving, from the second UE using a first receive beam associated with the first transmit beam, an indication of a resource collision associated with the first UE, the second UE, and a third UE. The method further comprises performing an action in response to the indication, wherein the action includes at least one of dropping the second message or re-transmitting, to the second UE, the PSSCH message with the scheduled resource for the second message.

In another aspect of the disclosure, a method of wireless communication performed by a first user equipment (UE), the method comprising receiving, from a second UE using a first receive beam, first sidelink control information (SCI) identifying a first scheduled resource for a second message and a physical sidelink shared channel (PSSCH) message. The method further comprises receiving, from a third UE using a second receive beam, second SCI identifying a second scheduled resource for a third message. The method further comprises transmitting, to the second UE, an indication of a resource collision associated with the first UE, the second UE, and the third UE.

In another aspect of the disclosure, a memory, a transceiver, and at least one processor coupled to the memory and the transceiver, wherein the memory stores instructions that are executable by the at least one processor, individually or in any combination, to cause the first UE to transmit, to a second UE using a first transmit beam, sidelink control information (SCI) identifying a scheduled resource for a second message and a physical sidelink shared channel (PSSCH) message. The first UE is further configured to receive, from the second UE using a first receive beam associated with the first transmit beam, an indication of a resource collision associated with the first UE, the second UE, and a third UE. The first UE is further configured to perform an action in response to the indication, wherein the action includes at least one of dropping the second message or re-transmitting, to the second UE, the PSSCH message with the scheduled resource for the second message.

In another aspect of the disclosure, a first UE comprises a memory, a transceiver, and at least one processor coupled to the memory and the transceiver, wherein the memory stores instructions that are executable by the at least one processor, individually or in any combination, to cause the first UE to receive, from a second UE using a first receive beam, first sidelink control information (SCI) identifying a first scheduled resource for a second message and a physical sidelink shared channel (PSSCH) message. The first UE is further configured to receive, from a third UE using a second receive beam, second SCI identifying a second scheduled resource for a third message. The first UE is further configured to transmit, to the second UE, an indication of a resource collision associated with the first UE, the second UE, and the third UE.

Other aspects, features, and embodiments of the present invention will become apparent to those of ordinary skill in the art upon reviewing the following description of specific, exemplary embodiments of the present invention in conjunction with the accompanying figures. While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with the various embodiments of the invention discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 illustrates a wireless communication network according to some aspects of the present disclosure.

FIG. 2 illustrates a wireless communication network that provisions for sidelink communications according to some aspects of the present disclosure.

FIG. 3 illustrates a sidelink communication scheme according to some aspects of the present disclosure.

FIG. 4A is a simplified communication diagram according to some aspects of the present disclosure.

FIG. 4B is a simplified communication diagram according to some aspects of the present disclosure.

FIG. 4C is a simplified communication diagram according to some aspects of the present disclosure.

FIG. 5 is a block diagram of an exemplary user equipment (UE) according to some aspects of the present disclosure.

FIG. 6 is a signaling diagram of a scheme for configuring collision detection parameters for sidelink communication according to some aspects of the present disclosure.

FIG. 7 is a signaling diagram of a scheme for sidelink communication with according to some aspects of the present disclosure.

FIG. 8 is a flow diagram of a method of sidelink communication according to some aspects of the present disclosure.

FIG. 9 is a flow diagram of a method of sidelink communication according to some aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

This disclosure relates generally to wireless communications systems, also referred to as wireless communications networks. In various embodiments, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, Global System for Mobile Communications (GSM) networks, 5th Generation (5G) or new radio (NR) networks, as well as other communications networks. As described herein, the terms “networks” and “systems” may be used interchangeably.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3rd Generation Partnership Project (3GPP) is a collaboration between groups of telecommunications associations that aims to define a globally applicable third generation (3G) mobile phone specification. 3GPP long term evolution (LTE) is a 3GPP project which was aimed at improving the UMTS mobile phone standard. The 3GPP may define specifications for the next generation of mobile networks, mobile systems, and mobile devices. The present disclosure is concerned with the evolution of wireless technologies from LTE, 4G, 5G, NR, and beyond with shared access to wireless spectrum between networks using a collection of new and different radio access technologies or radio air interfaces.

5G networks contemplate diverse deployments, diverse spectrum, and diverse services and devices that may be implemented using an OFDM-based unified, air interface. In order to achieve these goals, further enhancements to LTE and LTE-A are considered in addition to development of the new radio technology for 5G NR networks. The 5G NR will be capable of scaling to provide coverage (1) to a massive Internet of things (IoTs) with a ultra-high density (e.g., ˜1M nodes/km²), ultra-low complexity (e.g., ˜10s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 ms), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

The 5G NR may be implemented to use optimized OFDM-based waveforms with scalable numerology and transmission time interval (TTI); having a common, flexible framework to efficiently multiplex services and features with a dynamic, low-latency time division duplex (TDD)/frequency division duplex (FDD) design; and with advanced wireless technologies, such as massive multiple input, multiple output (MIMO), robust millimeter wave (mmWave) transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD/TDD implementations, subcarrier spacing may occur with 15 kHz, for example over 5, 10, 20 MHZ, and the like bandwidth (BW). For other various outdoor and small cell coverage deployments of TDD greater than 3 GHZ, subcarrier spacing may occur with 30 kHz over 80/100 MHZ BW. For other various indoor wideband implementations, using a TDD over the unlicensed portion of the 5 GHz band, the subcarrier spacing may occur with 60 KHz over a 160 MHz BW. Finally, for various deployments transmitting with mmWave components at a TDD of 28 GHz, subcarrier spacing may occur with 120 kHz over a 500 MHz BW.

The scalable numerology of the 5G NR facilitates scalable TTI for diverse latency and quality of service (QOS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with UL/downlink scheduling information, data, and acknowledgement in the same subframe. The self-contained integrated subframe supports communications in unlicensed or contention-based shared spectrum, adaptive UL/downlink that may be flexibly configured on a per-cell basis to dynamically switch between UL and downlink to meet the current traffic needs.

Various other aspects and features of the disclosure are further described below. It should be apparent that the teachings herein may be embodied in a wide variety of forms and that any specific structure, function, or both being disclosed herein is merely representative and not limiting. Based on the teachings herein one of an ordinary level of skill in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. For example, a method may be implemented as part of a system, device, apparatus, and/or as instructions stored on a computer readable medium for execution on a processor or computer. Furthermore, an aspect may comprise at least one element of a claim.

Sidelink communications refers to the communications among user equipment devices (UEs) without tunneling through a base station (BS) and/or a core network (e.g., via a PC5 link instead). Sidelink communication can be communicated over a physical sidelink control channel (PSCCH), a physical sidelink shared channel (PSSCH), a physical sidelink feedback channel (PSFCH), etc. The PSCCH is analogous to a physical downlink control channel (PDCCH) and the PSSCH to a physical downlink shared channel (PDSCH) in downlink (DL) communication between a BS and a UE. For instance, the PSCCH may carry sidelink control information (SCI) and the PSSCH may carry sidelink data. Each PSCCH is associated with a corresponding PSSCH, where SCI in a PSCCH may carry scheduling information for sidelink data transmission in the associated PSSCH. In some examples, a UE may transmit PSSCH carrying SCI, which may be indicated in multiple stages (e.g., two stages, three stages, and/or the like).

In a first stage control (also referred to herein as SCI-1), the UE may transmit PSCCH carrying information for resource allocation and decoding a second stage control. The first stage SCI may include at least one of a priority, resource reservation, resource reservation period (if enabled), PSSCH DMRS pattern (if more than one pattern is configured), a second-stage SCI format (e.g., size of a second SCI), an amount of resources for the second-stage SCI, a number of PSSCH demodulation reference signal (DMRS) port(s), a modulation and coding scheme (MCS), etc. In a second stage control (also referred to herein as SCI-2), the UE may transmit information for decoding the user data on PSSCH. The SCI-2 may include a 16-bit L1 destination identifier (ID), an 8-bit L1 source ID, a HARQ process ID, a new data indicator (NDI), a redundancy version (RV), and additional data as described herein according to embodiments of the present disclosure. Sidelink communication can also be communicated over a physical sidelink feedback control channel (PSFCH), which indicates an acknowledgement (ACK)-negative acknowledgement (NACK) for a previously transmitted PSSCH. Use cases for sidelink communication may include vehicle-to-everything (V2X), industrial IoT (IIoT), and/or NR-lite (to name a few examples).

As used herein, the term “sidelink UE” can refer to a user equipment device performing a device-to-device communication or other types of communications with another user equipment device independent of any tunneling through the BS (e.g., gNB) and/or an associated core network. As used herein, the terms “sidelink transmitting UE” and “transmitting UE” can refer to a user equipment device performing a sidelink transmission operation. As used herein, the terms “sidelink receiving UE” and “receiving UE” can refer to a user equipment device performing a sidelink reception operation.

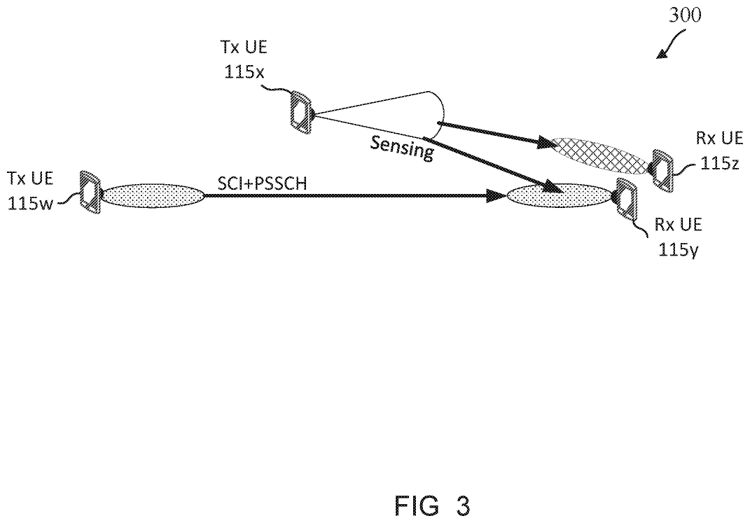

The present application describes mechanisms for beam based collision detection with inter-UE coordination on sidelink. Without a base station or other network device scheduling resources (i.e., time and frequency) for communication, in the sidelink context, UEs may schedule communications directly between each other. A sidelink control information (SCI) message transmitted from one UE to another may contain resource scheduling information for subsequent transmissions. In some sidelink systems, SCI messages are broadcast such that any UE could receive the SCI message and know what resources are being scheduled, even if the listening UE is not the UE which is being scheduled for communication. In this way, a UE may attempt to avoid interference with other UEs. However, in some circumstances, such as when using higher frequency communication, UEs may transmit SCIs via relatively narrow beams, rather than broadcasting wide. In this case, depending on the physical locations of the UEs, a UE may not receive an SCI, but still be affected by the resources associated with that SCI, without a chance to adapt in order to avoid that interference (e.g., as described in FIG. 3).

There may be at least three types of collisions which may occur in sidelink communications. First, a UE may be scheduled to transmit to two other UEs at the same time using the same or overlapping frequency resources. Second, a UE may be scheduled to receive from two other UEs at the same time using incompatible receive beams (e.g., two beams in different directions). This may be referred to as a receive beam collision. Third, a UE may be scheduled for transmit to two different UEs at the same time using two incompatible transmit beams (e.g., two beams in different directions). This may be referred to as a transmit beam collision. A transmit beam collision may occur when a UE receives messages from two UEs within the same PSFCH period, fails to decode both, and therefore has a HARQ NACK to transmit back to each of the transmitting UEs at the same PSFCH occasion, but each of the two UEs is located in a different direction and therefore associated with a different beam. In order for the transmitting UEs (which do not receive the SCI transmissions from each other) to avoid such collisions, the receiving UE may report a collision indication back to the transmitting UEs. In some aspects, an indication that a collision is detected may be implemented may be included in PSFCH (or alternative signaling such as MAC-CE) as discussed in detail below. In response to receiving a collision indication, the transmitting UEs may perform some corrective action such as dropping a message that would collide, or re-transmitting a message.

Aspects of the present disclosure provide several benefits. For example, UEs communicating in sidelink may do so in a more robust fashion, correcting for resource and beam incompatibilities. Aspects described herein allow for UEs to transmit SCI messages using narrow beams, while still enabling UEs to correct for collisions. This may simplify communication as beams may be used for both SCI and PSSCH messages, and reduces the amount of power needed as a targeted beam may focus a smaller amount of energy in only the necessary beam direction.

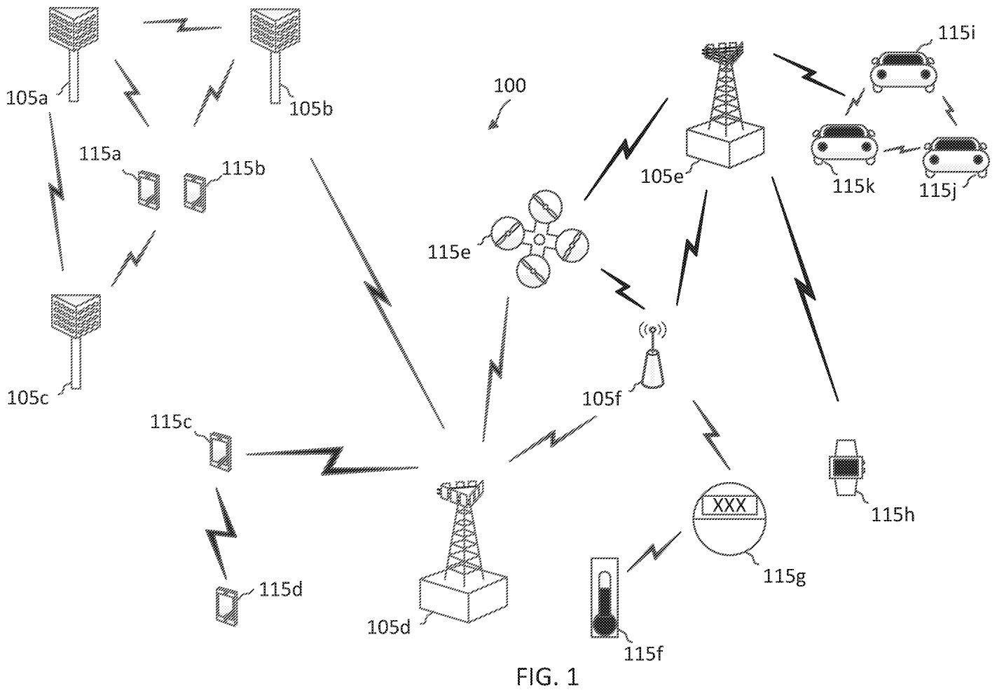

FIG. 1 illustrates a wireless communication network 100 according to some aspects of the present disclosure. The network 100 may be a 5G network. The network 100 includes a number of base stations (BSs) 105 (individually labeled as 105a, 105b, 105c, 105d, 105c, and 105f) and other network entities. A BS 105 may be a station that communicates with UEs 115 and may also be referred to as an evolved node B (eNB), a next generation eNB (gNB), an access point, and the like. Each BS 105 may provide communication coverage for a particular geographic area. In 3GPP, the term “cell” can refer to this particular geographic coverage area of a BS 105 and/or a BS subsystem serving the coverage area, depending on the context in which the term is used.

A BS 105 may provide communication coverage for a macro cell or a small cell, such as a pico cell or a femto cell, and/or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A BS for a macro cell may be referred to as a macro BS. A BS for a small cell may be referred to as a small cell BS, a pico BS, a femto BS or a home BS. In the example shown in FIG. 1, the BSs 105d and 105e may be regular macro BSs, while the BSs 105a-105c may be macro BSs enabled with one of three dimension (3D), full dimension (FD), or massive MIMO. The BSs 105a-105c may take advantage of their higher dimension MIMO capabilities to exploit 3D beamforming in both elevation and azimuth beamforming to increase coverage and capacity. The BS 105f may be a small cell BS which may be a home node or portable access point. A BS 105 may support one or multiple (e.g., two, three, four, and the like) cells.

The network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time.

The UEs 115 are dispersed throughout the wireless network 100, and each UE 115 may be stationary or mobile. A UE 115 may also be referred to as a terminal, a mobile station, a subscriber unit, a station, or the like. A UE 115 may be a cellular phone, a personal digital assistant (PDA), a wireless modem, a wireless communication device, a handheld device, a tablet computer, a laptop computer, a cordless phone, a wireless local loop (WLL) station, or the like. In one aspect, a UE 115 may be a device that includes a Universal Integrated Circuit Card (UICC). In another aspect, a UE may be a device that does not include a UICC. In some aspects, the UEs 115 that do not include UICCs may also be referred to as IoT devices or internet of everything (IoE) devices. The UEs 115a-115d are examples of mobile smart phone-type devices accessing network 100. A UE 115 may also be a machine specifically configured for connected communication, including machine type communication (MTC), enhanced MTC (eMTC), narrowband IoT (NB-IoT) and the like. The UEs 115e-115h are examples of various machines configured for communication that access the network 100. The UEs 115i-115k are examples of vehicles equipped with wireless communication devices configured for communication that access the network 100. A UE 115 may be able to communicate with any type of the BSs, whether macro BS, small cell, or the like. In FIG. 1, a lightning bolt (e.g., communication links) indicates wireless transmissions between a UE 115 and a serving BS 105, which is a BS designated to serve the UE 115 on the downlink (DL) and/or uplink (UL), desired transmission between BSs 105, backhaul transmissions between BSs, or sidelink transmissions between UEs 115 (such as and including according to embodiments of the present disclosure).

In operation, the BSs 105a-105c may serve the UEs 115a and 115b using 3D beamforming and coordinated spatial techniques, such as coordinated multipoint (CoMP) or multi-connectivity. The macro BS 105d may perform backhaul communications with the BSs 105a-105c, as well as with small cells, such as the BS 105f. The macro BS 105d may also transmit multicast services which are subscribed to and received by the UEs 115c and 115d. Such multicast services may include mobile television or stream video, or may include other services for providing community information, such as weather emergencies or alerts, such as Amber alerts or gray alerts.

The BSs 105 may also communicate with a core network. The core network may provide user authentication, access authorization, tracking, Internet Protocol (IP) connectivity, and other access, routing, or mobility functions. At least some of the BSs 105 (e.g., which may be an example of a gNB or an access node controller (ANC)) may interface with the core network through backhaul links (e.g., NG-C, NG-U, etc.) and may perform radio configuration and scheduling for communication with the UEs 115. In various examples, the BSs 105 may communicate, either directly or indirectly (e.g., through core network), with each other over backhaul links (e.g., X1, X2, etc.), which may be wired or wireless communication links.

The network 100 may also support mission critical communications with ultra-reliable and redundant links for mission critical devices, such as the UE 115c, which may be a drone. Redundant communication links with the UE 115e may include links from the macro BSs 105d and 105e, as well as links from the small cell BS 105f. Other machine type devices, such as the UE 115f (e.g., a thermometer), the UE 115g (e.g., smart meter), and UE 115h (e.g., wearable device) may communicate through the network 100 either directly with BSs, such as the small cell BS 105f, and the macro BS 105c, or in multi-step-size configurations by communicating with another user device which relays its information to the network, such as the UE 115f communicating temperature measurement information to the smart meter, the UE 115g, which is then reported to the network through the small cell BS 105f. The network 100 may also provide additional network efficiency through dynamic, low-latency TDD/FDD communications, such as V2V, V2X, C-V2X communications between a UE 115i, 115j, or 115k and other UEs 115, and/or vehicle-to-infrastructure (V2I) communications between a UE 115i, 115j, or 115k and a BS 105 (e.g., PC5 etc.).

In some implementations, the network 100 utilizes OFDM-based waveforms for communications. An OFDM-based system may partition the system BW into multiple (K) orthogonal subcarriers, which are also commonly referred to as subcarriers, tones, bins, or the like. Each subcarrier may be modulated with data. In some instances, the subcarrier spacing between adjacent subcarriers may be fixed, and the total number of subcarriers (K) may be dependent on the system BW. The system BW may also be partitioned into subbands (i.e., sub-channels). In other instances, the subcarrier spacing (SCS) and/or the duration of TTIs may be scalable.

Both LTE and NR UEs 115 coexist in network 100. In this discussion, NR devices includes devices that are capable of both NR and LTE communication, and generally LTE devices are only capable of LTE communication. LTE generally uses a subcarrier spacing (SCS) of 15 kHz. For NR, SCS is configurable (e.g., either 15 kHz, 30 kHz, or 60 kHz), although typically uses a 30 kHz SCS. OFDM transmission schemes allow for signals of a single SCS to be orthogonal to each other, but with adjacent resources using different SCS values, signals nearby in frequency to each other may cause excessive interference. For example, a sub-channel for LTE communication using a 15 kHz SCS adjacent to an NR sub-channel using a 30 kHz SCS would result in the NR signals interfering with the LTE signals. Especially in circumstances where the power level of the NR signals is higher relative to the LTE signals, the signal to noise ratio may be decreased substantially.

In some aspects, the BSs 105 can assign or schedule transmission resources (e.g., in the form of time-frequency resource elements (RE)) for downlink (DL) and uplink (UL) transmissions in the network 100. DL refers to the transmission direction from a BS 105 to a UE 115, whereas UL refers to the transmission direction from a UE 115 to a BS 105. The communication can be in the form of radio frames. A radio frame may be divided into a plurality of subframes or slots, for example, about 10. Each slot may be further divided into mini-slots. In a FDD mode, simultaneous UL and DL transmissions may occur in different frequency bands. For example, each subframe includes a UL subframe in a UL frequency band and a DL subframe in a DL frequency band. In a TDD mode, UL and DL transmissions occur at different time periods using the same frequency band. For example, a subset of the subframes (e.g., DL subframes) in a radio frame may be used for DL transmissions and another subset of the subframes (e.g., UL subframes) in the radio frame may be used for UL transmissions.

The DL subframes and the UL subframes can be further divided into several regions. For example, each DL or UL subframe may have pre-defined regions for transmissions of reference signals, control information, and data. Reference signals are predetermined signals that facilitate the communications between the BSs 105 and the UEs 115. For example, a reference signal can have a particular pilot pattern or structure, where pilot tones may span across an operational BW or frequency band, each positioned at a pre-defined time and a pre-defined frequency. For example, a BS 105 may transmit cell specific reference signals (CRSs) and/or channel state information-reference signals (CSI-RSs) to enable a UE 115 to estimate a DL channel. Similarly, a UE 115 may transmit sounding reference signals (SRSs) to enable a BS 105 to estimate a UL channel. Control information may include resource assignments and protocol controls. Data may include protocol data and/or operational data. In some aspects, the BSs 105 and the UEs 115 may communicate using self-contained subframes. A self-contained subframe may include a portion for DL communication and a portion for UL communication. A self-contained subframe can be DL-centric or UL-centric. A DL-centric subframe may include a longer duration for DL communication than for UL communication. A UL-centric subframe may include a longer duration for UL communication than for UL communication.

In some aspects, the network 100 may be an NR network deployed over a licensed spectrum. The BSs 105 can transmit synchronization signals (e.g., a PSS and a SSS) in the network 100 to facilitate synchronization. The BSs 105 can broadcast system information associated with the network 100 (e.g., including a master information block (MIB), remaining minimum system information (e.g., RMSI), and other system information (OSI)) to facilitate initial network access. In some instances, the BSs 105 may broadcast the PSS, the SSS, and/or the MIB in the form of synchronization signal block (SSBs) over a physical broadcast channel (PBCH) and may broadcast the RMSI and/or the OSI over a physical downlink shared channel (e.g., PDSCH).

In some aspects, a UE 115 attempting to access the network 100 may perform an initial cell search by detecting a PSS from a BS 105. The PSS may enable synchronization of period timing and may indicate a physical layer identity value. The UE 115 may then receive a SSS. The SSS may enable radio frame synchronization, and may provide a cell identity value, which may be combined with the physical layer identity value to identify the cell. The PSS and the SSS may be located in a central portion of a carrier or any suitable frequencies within the carrier.

After receiving the PSS and SSS, the UE 115 may receive a MIB. The MIB may include system information for initial network access and scheduling information for RMSI and/or OSI. After decoding the MIB, the UE 115 may receive RMSI and/or OSI. The RMSI and/or OSI may include radio resource control (RRC) information related to random access channel (RACH) procedures, paging, control resource set (CORESET) for physical downlink control channel (PDCCH) monitoring, physical UL control channel (PUCCH), physical UL shared channel (PUSCH), power control, and SRS.

After obtaining the MIB, the RMSI and/or the OSI, the UE 115 can perform a random access procedure to establish a connection with the BS 105. In some examples, the random access procedure may be a four-step random access procedure. For example, the UE 115 may transmit a random access preamble and the BS 105 may respond with a random access response. The random access response (RAR) may include a detected random access preamble identifier (ID) corresponding to the random access preamble, timing advance (TA) information, a UL grant, a temporary cell-radio network temporary identifier (C-RNTI), and/or a backoff indicator. Upon receiving the random access response, the UE 115 may transmit a connection request to the BS 105 and the BS 105 may respond with a connection response. The connection response may indicate a contention resolution. In some examples, the random access preamble, the RAR, the connection request, and the connection response can be referred to as message 1 (MSG1), message 2 (MSG2), message 3 (MSG3), and message 4 (MSG4), respectively. In some examples, the random access procedure may be a two-step random access procedure, where the UE 115 may transmit a random access preamble and a connection request in a single transmission and the BS 105 may respond by transmitting a random access response and a connection response in a single transmission.

After establishing a connection, the UE 115 and the BS 105 can enter a normal operation stage, where operational data may be exchanged. For example, the BS 105 may schedule the UE 115 for UL and/or DL communications. The BS 105 may transmit UL and/or DL scheduling grants to the UE 115 via a PDCCH. The scheduling grants may be transmitted in the form of DL control information (DCI). The BS 105 may transmit a DL communication signal (e.g., carrying data) to the UE 115 via a PDSCH according to a DL scheduling grant. The UE 115 may transmit a UL communication signal to the BS 105 via a PUSCH and/or PUCCH according to a UL scheduling grant.

In some aspects, the BS 105 may communicate with a UE 115 using HARQ techniques to improve communication reliability, for example, to provide a URLLC service. The BS 105 may schedule a UE 115 for a PDSCH communication by transmitting a DL grant in a PDCCH. The BS 105 may transmit a DL data packet to the UE 115 according to the schedule in the PDSCH. The DL data packet may be transmitted in the form of a transport block (TB). If the UE 115 receives the DL data packet successfully, the UE 115 may transmit a HARQ ACK to the BS 105.

Conversely, if the UE 115 fails to receive the DL transmission successfully, the UE 115 may transmit a HARQ NACK to the BS 105. Upon receiving a HARQ NACK from the UE 115, the BS 105 may retransmit the DL data packet to the UE 115. The retransmission may include the same coded version of DL data as the initial transmission. Alternatively, the retransmission may include a different coded version of the DL data than the initial transmission. The UE 115 may apply soft-combining to combine the encoded data received from the initial transmission and the retransmission for decoding. The BS 105 and the UE 115 may also apply HARQ for UL communications using substantially similar mechanisms as the DL HARQ.

In some aspects, the network 100 may operate over a system BW or a component carrier (CC) BW. The network 100 may partition the system BW into multiple BWPs (e.g., portions). A BS 105 may dynamically assign a UE 115 to operate over a certain BWP (e.g., a certain portion of the system BW). The assigned BWP may be referred to as the active BWP. The UE 115 may monitor the active BWP for signaling information from the BS 105. The BS 105 may schedule the UE 115 for UL or DL communications in the active BWP. In some aspects, a BS 105 may assign a pair of BWPs within the CC to a UE 115 for UL and DL communications. For example, the BWP pair may include one BWP for UL communications and one BWP for DL communications.

In some aspects, the network 100 may operate over a shared channel, which may include shared frequency bands and/or unlicensed frequency bands. For example, the network 100 may be an NR-U network operating over an unlicensed frequency band. In such an aspect, the BSs 105 and the UEs 115 may be operated by multiple network operating entities. To avoid collisions, the BSs 105 and the UEs 115 may employ a listen-before-talk (LBT) procedure to monitor for transmission opportunities (TXOPs) in the shared channel. A TXOP may also be referred to as COT (e.g., a channel occupancy time). For example, a transmitting node (e.g., a BS 105 or a UE 115) may perform an LBT prior to transmitting in the channel. When the LBT passes, the transmitting node may proceed with the transmission. When the LBT fails, the transmitting node may refrain from transmitting in the channel.

In some aspects, the network 100 may support stand-alone sidelink communication among the UEs 115 over a shared radio frequency band. NR supports multiple modes of radio resource allocations (RRA), including a mode-1 RRA and a mode-2 RRA, for sidelink over a licensed spectrum. The mode-1 RRA supports network controlled RRA that can be used for in-coverage sidelink communication. For this mode, there is significant base station involvement and is typically operable when the sidelink UE 115 is within the coverage area of the serving BS 105, but not necessarily for out-of-coverage sidelink scenarios. The mode-2 RRA supports autonomous RRA that can be used for out-of-coverage sidelink UEs 115 or partial-coverage sidelink UEs 115.

Alternatively, a stand-alone system may include a sidelink UE 115 designated as an anchor UE (e.g., an anchor node). The anchor UE 115 may initiate sidelink operations with one or more client UEs 115 autonomously (e.g., independent of any cell and/or associated core network). Accordingly, the anchor UE 115 may announce system parameters (e.g., information associated with a sidelink master information block (SL-MIB), remaining minimum system information (RMSI), primary synchronization signal (PSS), secondary synchronization signal (SSS), and/or the like) for the operation of each of the client UEs 115, and the anchor UE 115 may provide respective radio resource control (RRC) configurations for corresponding client UEs 115. For example, the anchor UE 115 may provide first RRC configurations to a first client UE 115 and different second RRC configurations to a second client UE 115. Moreover, while the anchor UE 115 may interface with the client UEs using mode-1 resource allocation or mode-2 resource allocation, the signaling received by the client UEs 115 may remain the same between the two resource allocation modes.

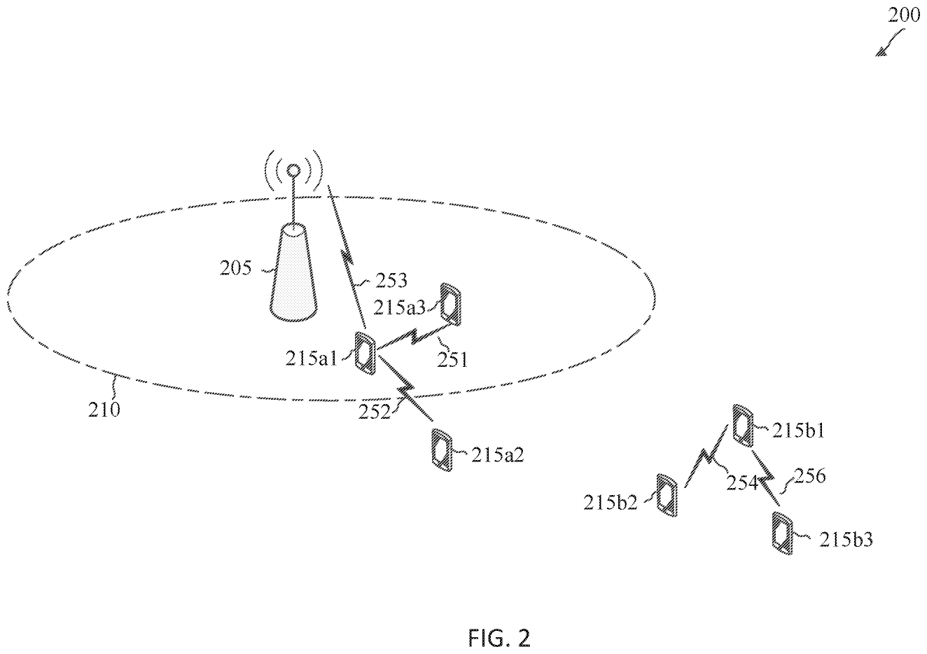

FIG. 2 illustrates an example of a wireless communication network 200 that provisions for sidelink communications according to aspects of the present disclosure. The network 200 may correspond to at least a portion of the network 100. FIG. 2 illustrates a BS 205 and six UEs 215 (shown as 215a1, 215a2, 215a3, 215b1, 215b2, and 215b3) for purposes of simplicity of discussion, though it will be recognized that aspects of the present disclosure may scale to any suitable number of UEs 215 and/or BSs 205. The BS 205 and the UEs 215 may be similar to the BSs 105 and the UEs 115, respectively. The BSs 205 and the UEs 215 may share the same radio frequency band (or at least a sub-band thereof) for communications. In some instances, the radio frequency band may be a 2.4 GHz unlicensed band, a 5 GHz unlicensed band, or a 6 GHz unlicensed band (or some other band, such as FR2). In general, the shared radio frequency band may be at any suitable frequency.

The BS 205 and the UEs 215a1-215a3 may be operated by a first network operating entity. The UEs 215b1-215b3 may be operated by a second network operating entity. In some aspects, the first network operating entity may utilize a same RAT as the second network operating entity. For instance, the BS 205 and the UEs 215a1-215a3 of the first network operating entity and the UEs 215b1-215b3 of the second network operating entity are NR-U devices. In some other aspects, the first network operating entity may utilize a different RAT than the second network operating entity. For instance, the BS 205 and the UEs 215a1-215a3 of the first network operating entity may utilize NR-U technology while the UEs 215b1-215b3 of the second network operating entity may utilize WiFi or LAA technology.

Both LTE and NR UEs 215 use dedicated sidelink resource pools, which are separate from the resources used for regular cellular communication via a BS 205. While a sidelink resource pool configuration indicates which RATs may be used for communication, it does not directly schedule resources for specific communications. Scheduling of communications may be done via sidelink scheduling, or assisted by a BS 205. A UE 215 capable of both NR and LTE communication may listen for scheduling messages on LTE, which may assist the UE 215 in determining what guard bands are necessary for its own communication on NR resources adjacent to LTE resources.

In the network 200, some of the UEs 215a1-215a3 and/or UEs 215b1-215b3 may communicate with each other in peer-to-peer communications. For example, the UE 215a1 may communicate with the UE 215a2 over a sidelink 252, the UE 215a1 may communicate with the UE 215a3 over another sidelink 251, the UE 215b1 may communicate with the UE 215b2 over yet another sidelink 254, and the UE 215b1 may communicate with the UE 215b3 over sidelink 256. The sidelinks 251, 252, 254, and 256 may be unicast bidirectional links. Some of the UEs 215 may also communicate with the BS 205 in a UL direction and/or a DL direction via communication links 253. For instance, the UE 215a1 and 215a3 are within a coverage area 210 of the BS 205, and thus may be in communication with the BS 205. The UE 215a2 is outside the coverage area 210, and thus may not be in direct communication with the BS 205. In some instances, the UE 215a1 may operate as a relay for the UE 215a2 to reach the BS 205. As an example, some of the UEs 215 may be associated with vehicles (e.g., similar to the UEs 115i-k) and the communications over the sidelinks 251, 252, 254, and 256 may be C-V2X communications. C-V2X communications may refer to communications between vehicles and any other wireless communication devices in a cellular network. This is exemplary only, as the sidelinks may be between any of a variety of different UE types and communications.

Similar to network 100 of FIG. 1, the network 200 may support sidelink communication among the UEs 215, including one or more modes supported by a BS 205, and/or one or more stand-alone modes that do not require BS 205 support. As part of the sidelink communication, a sidelink UE, such as 215b1 (as just one example), may seek channel state information from another sidelink UE, such as 215b2 in this example. This may be sought aperiodically. As a result, the UE 215b1 may transmit a request for channel state information (e.g., by asserting one or more bits in an SCI-2 message to the UE 215b2), along with a reference signal, to the UE 215b2. The UE 215b2 may measure the channel based on the reference signal (as triggered by the request), and generate a channel state information report.

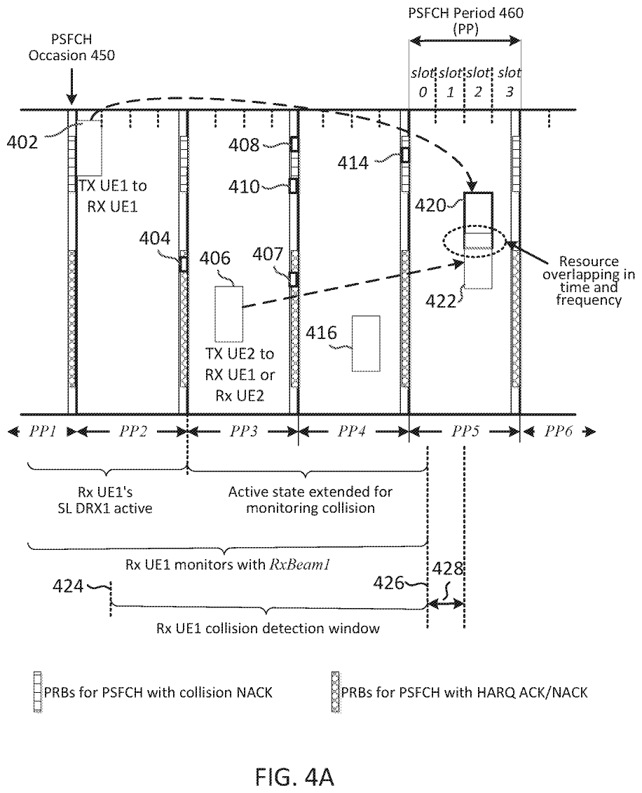

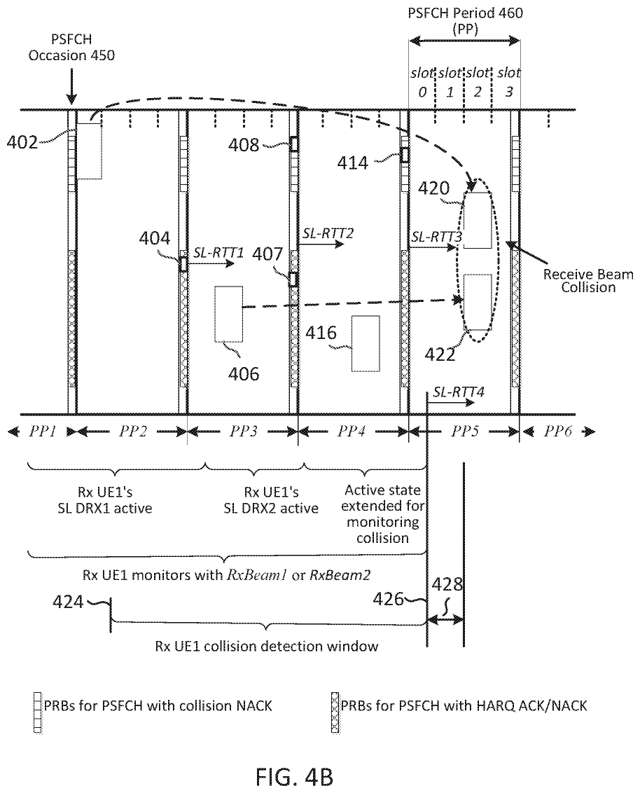

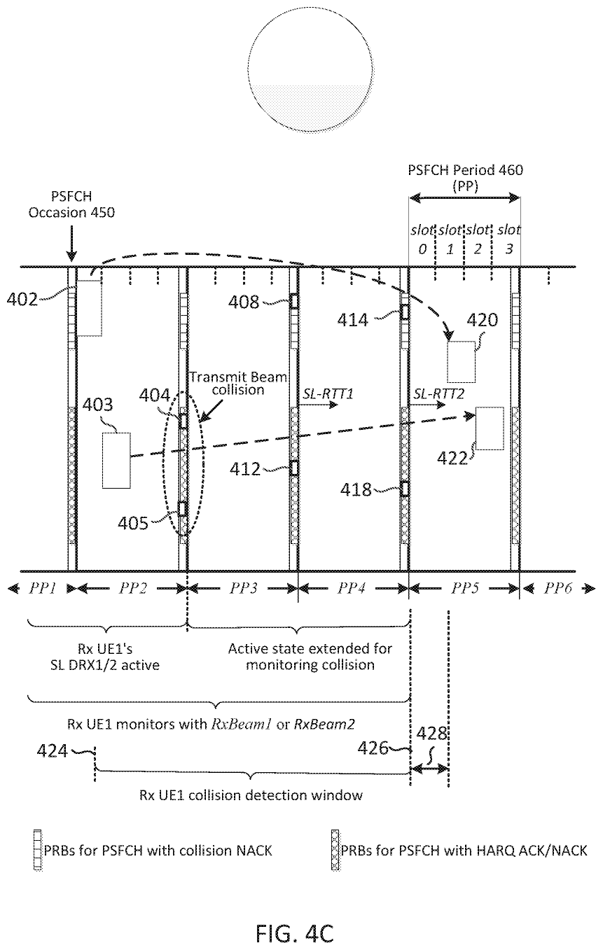

FIG. 3 illustrates a sidelink communication scheme 300 according to some aspects of the present disclosure. Sidelink communication scheme 300 includes two transmitting UEs 115w and 115x, and two receiving UEs 115y and 115z. Transmitting UE 115w transmits a SCI and PSSCH to RX UE 115y, using a first beam. Note that since this beam is relatively narrow, transmitting UE 115x is not able to sense the message, and is therefore blind as to what resources are being scheduled for receiving UE 115y. Transmitting UE 115x may also transmit an SCI and PSSCH to receiving UE 115y and/or to receiving UE 115z. Since transmitting UE 115x did not sense the SCI from transmitting UE 115w, it may naively schedule resources with receiving UE 115y and/or 115z which conflict (collide) with those scheduled by transmitting UE 115w. Receiving UE 115y may determine that it has been scheduled with conflicting resources, and may communicate a collision indication to transmitting UE 115w and/or 115x as described in more detail herein, for example with reference to FIGS. 4A-4C.

FIG. 4A is a simplified communication diagram according to some aspects of the present disclosure. The communication diagram in FIG. 4A illustrates an example of a resource (time and frequency) collision. The horizontal axis represents time in some units, with divisions including PSFCH periods (PP1-PP6) 460, where each PSFCH period 460 includes a PSFCH occasion 450 for transmitting sidelink feedback. Each PSFCH period 460 may be subdivided into a number of slots, for example four slots as illustrated with slots 0-3 for each PSFCH period. The vertical axis represents frequency, which may be subdivided into predefined frequency resources (e.g., subchannels or resource blocks (RBs) or physical resource block (PRBs). Each PSFCH occasion 450 may include a subset of resources (e.g., RBs or PRBs) allocated for HARQ feedback, and a separate subset of resources allocation for collision indication feedback (e.g., RBs or PRBs). The exact time and frequency locations of each of the messages illustrated are exemplary.

Message 402 is transmitted from a first transmitting (Tx) UE (Tx UE1 as shown in FIG. 4A) (e.g., using a first transmit beam (e.g., TxBeam1)) to a first receiving (Rx) UE (Rx UE1 as shown in FIG. 4A) (e.g., using a first receive beam (e.g., RxBeam1) which is paired with the first transmit beam (e.g., TxBeam1) of the first Tx UE) and includes an SCI which reserves resource(s) 420 for the transmission(s) to the first Rx UE in PP5. In some aspects, resource(s) 420 is reserved for retransmission(s) of a message originally transmitted in message 402 in case the first Rx UE fails to decode. HARQ feedback 404 (e.g., transmitted by the first Rx UE using a transmit beam corresponding to (e.g., based on the beam correspondence between transmit beam and receive beam of a UE) the first receive beam (e.g., RxBeam1) and monitored and received by the first Tx UE using a receive beam corresponding to (e.g., based on the beam correspondence between receive beam and transmit beam of a UE) the first transmit beam (e.g., TxBeam1) at the PSFCH occasion in PP2) may indicate a HARQ NACK associated with message 402, which may cause the first Tx UE to use resource(s) 420 for a retransmission(s). In other aspects, resource(s) 420 may be reserved for a transmission(s) by the first Tx UE and reception by the first Rx UE independent of the PSSCH message in message 402 (e.g., a transmission with a new TB on PSSCH).

Message 406 is transmitted from a second transmitting (Tx) UE (Tx UE2 as shown in FIG. 4A) (e.g., using a second transmit beam (e.g., TxBeam2)) to the first receiving (Rx) UE (Rx UE1 as shown in FIG. 4A) (e.g., using a second receive beam (e.g., RxBeam2) which is paired with the second transmit beam (e.g., TxBeam2) of the second Tx UE) and includes an SCI which reserves resource(s) 422 for the transmission(s) to the first Rx UE in PP5. In some aspects, resource(s) 422 is reserved for retransmission(s) of a PSSCH message originally transmitted in message 406 in case the first Rx UE fails to decode. HARQ feedback 407 (e.g., transmitted by the first Rx UE using a transmit beam corresponding to the second receive beam (e.g., RxBeam2) and monitored and received by the second Tx UE musing a receive beam corresponding to the second transmit beam (e.g., TxBeam2) at the PSFCH occasion in PP3) may indicate a HARQ NACK associated with message 406, which may cause the second Tx UE to use resource(s) 422 for a retransmission(s). In other aspects, resource(s) 422 may be reserved for a transmission(s) by the second Tx UE and reception by the first Rx UE independent of the PSSCH message in message 406 (e.g., a transmission with a new TB on PSSCH).

In some aspects, message 406 is transmitted from a second transmitting (Tx) UE (Tx UE2 as shown in FIG. 4A) (e.g., using a third transmit beam (e.g., TxBeam3)) to a second receiving (Rx) UE (Rx UE2 as shown in FIG. 4A) (e.g., using a third receive beam (e.g., RxBeam3) which is paired with the third transmit beam (e.g., TxBeam3) of the second Tx UE, where the third transmit beam (e.g., TxBeam3) or the third receive beam (e.g., RxBeam3) may respectively have same or similar TCI state (e.g., QCL type D) or spatial filtering (e.g., fully or partially overlapping in direction or space) with the first transmit beam (e.g., TxBeam1) of the first Tx UE or the first receive beam (e.g., RxBeam1) of the first Rx UE (e.g., paired with the TxBeam1 of the first Tx UE) which may cause interference to the first Rx UE using the RxBeam1) and includes an SCI which reserves resource(s) 422 for the second Rx UE in PP5. In some aspects, resource(s) 422 is reserved for retransmission(s) of a PSSCH message originally transmitted in message 406 in case the second Rx UE fails to decode. HARQ feedback 407 (e.g., transmitted by the second Rx UE using a transmit beam corresponding to the third receive beam (e.g., RxBeam3) and monitored and received by the second Tx UE using a receive beam corresponding to the third transmit beam (e.g., TxBeam3) at the PSFCH occasion in PP3) may indicate a HARQ NACK associated with message 406, which may cause the second Tx UE to use resource(s) 422 for a retransmission(s). In other aspects, resource(s) 422 may be reserved for a transmission(s) by the second Tx UE and reception by the second Rx UE independent of the PSSCH message in message 406 (e.g., a transmission with a new TB on PSSCH).

As illustrated, resource(s) 420 (e.g., with the transmission(s) to be transmitted by the first Tx UE on the first transmit beam (e.g., TxBeam1) and to be received by the first Rx UE on the first receive beam (e.g., RxBeam1) paired with the first transmit beam) and resource(s) 422 (e.g., with the transmission(s) to be transmitted by the second Tx UE on the second transmit beam (e.g., TxBeam2) and to be received by the first Rx UE on the second receive beam (e.g., RxBeam2) paired with the second transmit beam) occur at the same time, with overlapping frequencies (e.g., partially or fully overlapped in frequency resources such as subchannel(s) or RB(s) or PRB(s)). The first Rx UE may not be capable of decoding two transmissions overlapping in time and frequency from two different transmitting UEs (e.g., using the first or second receive beam (e.g., RxBeam1 or RxBeam2). The first Rx UE may communicate to the first and/or second Tx UEs a resource collision indication (e.g., a one-bit sequence indicating a collision like a HARQ NACK sequence transmitted with one-bit PSFCH) using the resources in the PSFCH occasion(s). For example, collision indication 408 may be transmitted by the first Rx UE (e.g., using the transmit beam corresponding to the first receive beam (e.g., RxBeam1) paired with the first transmit beam (e.g., TxBeam1) of the first Tx UE) and received by the first Tx UE (e.g., using the receive beam corresponding to the first transmit beam (e.g., TxBeam1) of the first Tx UE), and collision indication 410 may be transmitted by the first Rx UE (e.g., using the transmit beam corresponding to the second receive beam (e.g., RxBeam2) paired with the second transmit beam (e.g., TxBeam2) of the second Tx UE) and received by the second Tx UE (e.g., using the receive beam corresponding to the second transmit beam (e.g., TxBeam2) of the second Tx UE) at the PSFCH occasion in PP3. In this case, both collision indications may be transmitted at the same PSFCH occasion using a transmit beam corresponding to the first or second receive beam of the first Rx UE where the first and second receive beams are same or similar (e.g., the RxBeam1 and RxBeam2 of the first Rx UE are the same beam or are with same or similar TCI state (e.g., quasi co-location (QCL) type D) or spatial filtering (e.g., fully or partially overlapping in direction or space)). If both collision indications cannot be transmitted together at the same PSFCH occasion (e.g., they require different transmit beam directions to two different Tx UEs to receive the collision indications respectively (e.g., using transmit beams respectively corresponding to RxBeam1 and RxBeam2 where RxBeam1 and RxBeam2 are not the same beam or not QCLed with type D at the first Rx UE)), then a collision indication may be sent in another PSFCH occasion. For example, collision indication 414 (e.g., at PSFCH occasion in PP4) may be transmitted by the first Rx UE to the first Tx UE (e.g., via a transmit beam corresponding to the first receiving beam (e.g., RxBeam1) for message 402).

In some aspects, as illustrated, resource(s) 420 (e.g., with the transmission(s) to be transmitted by the first Tx UE on the first transmit beam (e.g., TxBeam1) and to be received by the first Rx UE on the first receive beam (e.g., RxBeam1) paired with the first transmit beam) and resource(s) 422 (e.g., with the transmission(s) to be transmitted by the second Tx UE on the third transmit beam (e.g., TxBeam3) and to be received by the second Rx UE on the third receive beam (e.g., RxBeam3) paired with the third transmit beam, where the third transmit beam (e.g., TxBeam3) or the third receive beam (e.g., RxBeam3) may respectively have same or similar TCI state or spatial filtering with the TCI state or spatial filtering of the first transmit beam (e.g., TxBeam1) or the first receive beam (e.g., RxBeam1)) occur at the same time, with overlapping frequencies (e.g., partially or fully overlapped in frequency resources such as subchannel(s) or RB(s) or PRB(s)). The first Rx UE may not be capable of decoding the transmission(s) at resource(s) 420 (e.g., using the first receive beam (e.g., RxBeam1)) overlapping in time and frequency with the transmission(s) at resource(s) 422 due to interference (e.g., the first Rx UE may receive the transmission(s) at resource(s) 422 using the first receive beam (e.g., RxBeam1) due to the same or similar TCI state or spatial filtering with the third receive beam (e.g., RxBeam3) of the second Rx UE, for example, the first Rx UE and the second Rx UE are collocated with same TCI state or spatial filtering or are close to each other with similar TCI state or spatial filtering). The first Rx UE may communicate to the first and/or second Tx UEs a collision indication using the resources in the PSFCH occasion. For example, collision indication 408 may be transmitted by the first Rx UE (e.g., using the transmit beam corresponding to the first receive beam (e.g., RxBeam1) paired with the first transmit beam (e.g., TxBeam1) of the first Tx UE) and received by the first Tx UE (e.g., using the receive beam corresponding to the first transmit beam (e.g., TxBeam1) of the first Tx UE) and collision indication 410 may be transmitted by the first Rx UE (e.g., using the transmit beam corresponding to the first receive beam (e.g., RxBeam1) paired with the first transmit beam (e.g., TxBeam1) of the first Tx UE) and received by the second Tx UE (e.g., using the receive beam corresponding to the third transmit beam (e.g., TxBeam3) of the second Tx UE, where the third transmit beam (e.g., TxBeam3) has the same or similar TCI state or spatial filtering with the first transmit beam (e.g., TxBeam1) of the first Tx UE) at the PSFCH occasion in PP3.

In some aspects, a collision (e.g., resource collision) is only indicated if it is determined by the receiving UE that the reserved resources will actually be used by both transmitting UEs. For example, if both messages 402 and 406 failed to decode, resulting in HARQ NACKs being transmitted, the receiving UE may determine that both reserved resources will be used for retransmission of the failed messages.

In some aspects, only one of the transmitting UEs is transmitted a resource collision indication, since if one of them drops the conflicting transmission(s) at the reserved resource(s), the other may keep the transmission(s) using the resource(s). The receiving UE may determine to which Tx to transmit a collision indication based on the QoS requirements of the conflicting transmissions (e.g., a priority order). For example, the SCI and/or PSSCH received in messages 402 and 406 may indicate a type of message and/or a priority value which may be used by the receiving UE to determine which message has a higher priority for retransmission. In some aspects, the transmitting UE which transmitted the lower priority message is the one to which the receiving UE transmits the collision indication.

The transmitting UE which receives a resource collision indication may drop the transmission(s) which was intended at the reserved resource(s). The dropped transmission(s) may be transmitted at a reselected resource(s) (e.g., using non-conflicting resource(s)).

The first and/or second Rx UEs may be configured with sidelink discontinuous reception (DRX). With sidelink DRX, the Rx UE cycles between listening for transmissions and/or retransmissions and transmitting HARQ feedback if enabled during a sidelink DRX active time, and waiting in a sleep state (e.g., for saving power) during a sidelink DRX inactive time. Normally a HARQ ACK/NACK would be received at the first PSFCH occasion after a message is transmitted. Because of this, the configured DRX active time may include the time until the first PSFCH occasion (e.g., a sidelink RTT timer is started at the first symbol after the first PSFCH occasion) and the time waiting for a retransmission (e.g., a sidelink HARQ retransmission timer is started after the sidelink RTT timer expires). However, since a collision detection requires the Rx UE to monitor resource reservations from other UEs within a collision detection window, which may start (e.g., at 424) after a received transmission (e.g., message 402) including reserved resource(s) in SCI for retransmission(s) or a new transmission(s) and end at a time (e.g., at 426) before the conflicting resources 420 (e.g., a time gap 428 preconfigured or configured or activated for the Tx UE to drop the transmission(s) at the conflicting resource(s) and reselect resource(s) for the transmission(s)), the sidelink DRX active time may need to be extended in order to monitor for collision detections. The exact sidelink DRX active time duration and extension durations may be values that are configurable (e.g., aligned with the collision detection window which may be preconfigured or configured or activated).

In some aspects, when an Rx UE is configured with one sidelink DRX for communicating with one Tx UE (e.g., the Rx UE is configured with SL DRX 1 with the first Tx UE in the case that the first Tx UE transmits message 402 to the first Rx UE and the second Tx UE transmits message 406 to the second Rx UE), the sidelink DRX active state may be extended based on the Rx UE's collision detection window (as shown in FIG. 4A) during which the Rx UE may monitor SCIs with resource reservations transmitted from other UEs (e.g. transmissions with messages 406 and 416) using an active receive beam (e.g., paired receive beam RxBeam1) and transmit collision indication(s) using a transmit beam corresponding to the active receive beam. A sidelink RTT timer may be started by the first Rx UE at the first symbol after transmitting a collision indication (e.g., earliest or latest based on collision indication parameters preconfigured or configured or activated) and a sidelink RTT timer may be started by the Tx UE (e.g., the first Tx UE or the second Tx UE) at the first symbol after receiving a collision indication within the collision detection window (e.g., earliest or latest based on collision indication parameters preconfigured or configured or activated, as described later in the connection of FIG. 4B). Accordingly, a sidelink HARQ retransmission timer may be started by the first Rx UE or the Tx UE (e.g., the first or second Tx UE) respectively for monitoring or transmitting a retransmission or a new transmission at the reserved resource 420 or reselected resource (e.g., after the reserved resource 420 if the reserved resource is dropped due to the collision detected) after the sidelink RTT timer expires.

In some aspects, when an Rx UE is configured with more than one sidelink DRX for communicating respectively to more than one Tx UE (e.g., the Rx UE is configured with SL DRX 1 with the first Tx UE and SL DRX2 with the second Tx UE in the case that the first Tx UE transmits message 402 to the first Rx UE and the second Tx UE transmits message 406 to the first Rx UE, as shown in FIG. 4B), a sidelink DRX active state (e.g., SL DRX1 with the first Tx UE or SL DRX 2 with the second Tx UE) may be extended based on the Rx UE's collision detection window during which the Rx UE may monitor SCIs with resource reservation transmitted from other UEs (e.g. transmissions with messages 406 and 416) using at least one of active receive beams (e.g., paired receive beams RxBeam1 and RxBeam2) and transmit collision indication(s) using at least one transmit beam corresponding respectively to the at least one of active receive beams (e.g., corresponding to RxBeam1 and/or RxBeam2). For example, the Rx UE may extend either sidelink DRX active state and detect collision(s) using one or both active receive beams and transmit a first collision indication to the first Tx UE using the transmit beam corresponding to a first active receive beam paired with the first Tx UE (e.g., corresponding to RxBeam1) and a second collision indication to the second Tx UE using the transmit beam corresponding to a second active receive beam paired with the second Tx UE (e.g., corresponding to RxBeam2) at different PSFCH occasions for collision indications. For another example, based on the priority of the received messages (e.g., message 402 for the first Tx UE and message 406 from the second Tx UE), the Rx UE may extend the sidelink DRX active state associated to the message with low or high priority and detect collision(s) using one or both active receive beams and transmit a collision indication to the Tx UE associated to the message with low or high priority (e.g., using the transmit beam corresponding to the active receive beam paired with the first Tx UE (e.g., corresponding to RxBeam1) or the second Tx UE (e.g., corresponding to RxBeam2) at a PSFCH occasion for the collision indication). Similarly, a sidelink RTT timer may be started by the first Rx UE at the first symbol after transmitting a collision indication (e.g., earliest or latest based on collision indication parameters preconfigured or configured or activated) and a sidelink RTT timer may be started by the Tx UE (e.g., the first Tx UE or the second Tx UE) at the first symbol after receiving a collision indication (e.g., earliest or latest collision indication within the collision detection window based on collision indication parameters preconfigured or configured or activated, as described later in the connection of FIG. 4B). Accordingly, a sidelink HARQ retransmission timer may be started by the first Rx UE or the Tx UE (e.g., the first or second Tx UE) respectively for monitoring or transmitting a retransmission or a new transmission at the reserved resource 420 or reselected resource (e.g., after the reserved resource 420 if the reserved resource is dropped due to the collision detected) after the sidelink RTT timer expires.

FIG. 4B is a simplified communication diagram according to some aspects of the present disclosure. The communication diagram in FIG. 4B illustrates an example of a receive beam collision. FIG. 4B illustrates time and frequency resources, similar to FIG. 4A, divided into PSFCH periods 460, with PSFCH occasions 450. Similar communications to those in FIG. 4A are illustrated with the same numbers, although differences may exist, for example which UE is transmitting and/or receiving specific messages. The exact time and frequency locations of each of the messages illustrated are exemplary.

Message 402 is transmitted from a first transmitting UE to a first receiving UE and includes an SCI which reserves resources 420 for the first receiving UE in PP5. Message 402 is transmitted using a first transmit beam (e.g., TxBeam1) and received using a first receive beam (e.g., RxBeam1) paired with the first transmit beam. Reserved resource 420 is scheduled to for the same transmit/receive beam pair (e.g., TxBeam1 at the first Tx UE and RxBeam1 at the first Rx UE). In some aspects, resources 420 are reserved for retransmission of a PSSCH message originally transmitted in message 402 in case the receiving UE fails to decode. HARQ feedback 404 may indicate a HARQ NACK associated with message 402, which may cause the first transmitting UE to use resources 420 for a retransmission. In other aspects, resources 420 may be used for a transmission by the first transmitting UE or a reception by the first receiving UE independent of the PSSCH message in message 402 (e.g., a transmission with a new TB on PSSCH).

Message 406 is transmitted from a second transmitting UE to the first receiving UE and includes an SCI which schedules resources 422 for the first receiving UE in PP5. Message 406 is transmitted by the second transmitting UE using a second transmit beam (e.g., TxBeam2) and received by the first receiving UE using a second receive beam (e.g., RxBeam2) paired with the second transmit beam. Reserved resource 422 is scheduled to for the same transmit/receive beam pair (e.g., TxBeam2 at the second Tx UE and RxBeam2 at the first Rx UE). In some aspects, resource(s) 422 is reserved for retransmission(s) of a PSSCH message originally transmitted in message 406 in case the receiving UE fails to decode. HARQ feedback 407 may indicate a HARQ NACK associated with message 406, which may cause the second transmitting UE to use resource(s) 422 for a retransmission(s). In other aspects, resource(s) 422 may be used for a transmission(s) by the second transmitting UE or a reception(s) by the first receiving UE independent of the PSSCH message in message 406 (e.g., a transmission with a new TB on PSSCH).

As illustrated, resources 420 and 422 occur at the same time, but at different frequencies. However, resources 420 are scheduled to receive from the first transmitting UE using the first receive beam (e.g., RxBeam1), while resources 422 are scheduled to receive from the second transmitting UE with the second receive beam (e.g., RxBeam2). These two beams may be incompatible for a number of reasons, which may each be referred to as a receive beam collision. For example, the first and second receive beams may be in different TCI states (e.g., with QCL type D) or spatial filters or directions, and the first receiving UE may only be capable of receiving from one transmitting UE at one direction at any given time using a receive beam associated with the direction (e.g., either from the first transmitting UE using RxBeam1 or the second transmitting UE using RxBeam2). In some aspects, the first and second receive beams may be in the same or similar TCI state (e.g., with QCL type D) or spatial filter or direction, and the first receiving UE may only be capable of receiving from different transmitting UEs at the same time using either receive beam associated with the same or similar direction (e.g., using either RxBeam1 or RxBeam2 from both the first transmitting UE and the second transmitting UE).

The first receiving UE may communicate to the first and/or second transmitting UEs a collision indication (e.g., receive beam collision) using the resources in the PSFCH occasion. For example, collision indication 408 may be transmitted to the second transmitting UE at the PSFCH occasion in PP3 (e.g., using the same transmit beam corresponding to the second receive beam RxBeam2 paired with the second transmitting UE for sending a HARQ NACK 407 to the second transmitting UE at the same PSFCH occasion in PP3) and collision indication 414 may be transmitted to the first transmitting UE at the PSFCH occasion in PP4 (e.g., using the transmit beam corresponding to the first receive beam RxBeam1 paired with the first transmitting UE). In this instance since the beams are incompatible, the collision indications cannot be transmitted together at the same time (e.g., they require different beam directions), so a collision indications are sent in separate PSFCH occasions.

In some aspects, a collision (e.g., receive beam collision) is only indicated if it is determined by the receiving UE that the reserved resources will actually be used by both transmitting UEs. For example, if both messages 402 and 406 failed to decode, resulting in HARQ NACKs being transmitted, the first receiving UE may determine that both reserved resources will be used for retransmission of the failed messages.

In some aspects, only one of the transmitting UEs is transmitted a collision indication, since if one of them drops the conflicting transmission, the other may use the resources. The receiving UE may determine to which UE to transmit a collision indication based on a priority order. For example, the SCI and/or PSSCH received in messages 402 and 406 may indicate a type of message and/or a priority value which may be used by the receiving UE to determine which message has a higher priority for retransmission. In some aspects, the transmitting UE which transmitted the lower priority message is the one to which the receiving UE transmits the collision indication.

The transmitting UE which receives a collision indication (e.g., indicating a receive beam collision) may drop the message which was intended for the reserved resources. The dropped message may be retransmitted at a reselected resource (e.g., using non-conflicting resources).

The first receiving UE may be configured with a first sidelink discontinuous reception (DRX) associated with the first transmitting UE (e.g., SL DRX1) and a second sidelink DRX associated with the second transmitting UE (e.g., SL DRX2 where the SL DRX2 active time may or may not overlap with SL DRX1 active time). With a sidelink DRX, the receiving UE cycles between listening for transmissions and/or retransmissions and transmitting HARQ ACK/NACK feedback if enabled during a sidelink DRX active time, and waiting in a sleep state (e.g., for saving power) during a sidelink DRX inactive time. Normally a HARQ feedback with ACK/NACK would be received at the first PSFCH occasion after a message is transmitted. Because of this, the configured DRX active time may include the time until the first PSFCH occasion (e.g., a sidelink RTT timer is started at the first symbol after a HARQ feedback with a NACK at the first PSFCH occasion) and the time waiting for a retransmission (e.g., a sidelink HARQ retransmission timer is started after the sidelink RTT timer expires). However, since a collision detection requires the Rx UE to monitor resource reservations from other UEs within a collision detection window, which may start (e.g., at 424) after a received transmission (e.g., message 402) including reserved resource(s) in SCI for retransmission(s) or a new transmission(s) and end at a time (e.g., at 426) before the conflicting resources 420 (e.g., a time gap 428 preconfigured or configured or activated for the Tx UE to drop the transmission(s) at the conflicting resource(s) and reselect resource(s) for the transmission(s)), the sidelink DRX active time may need to be extended in order to monitor for collision detections. The exact sidelink DRX active time duration and extension durations may be values that are configurable (e.g., aligned with the collision detection window which may be preconfigured or configured or activated).

In some aspects, the first sidelink DRX (e.g., SL DRX1) active time or state may not be extended after the first PSFCH occasion for a HARQ ACK if the reserved resource(s) 420 is for a retransmission(s) (e.g., no collision detection for reserved resource(s) to be used for retransmission(s)) and a sidelink RTT timer may be started at the first symbol after the first PSFCH occasion (e.g., start with SL-RTT1 running after transmitting the HARQ ACK at 404 by the receiving UE and receiving the HARQ ACK at 404 by the first transmitting UE); otherwise the first sidelink DRX (e.g., SL DRX1) active time or state may be extended after the first PSFCH occasion for a HARQ NACK at 404 if the reserved resource(s) 420 is for a retransmission(s) or after the reception of message 402 (e.g., without HARQ ACK/NACK at 404) if the reserved resource(s) 420 is for a new transmission(s) and sidelink RTT timer may not be started at the first symbol after the PSFCH occasion with a HARQ NACK at 404 for retransmission(s) at resource(s) 420 or after the reception of message 402 (e.g., with no HARQ ACK/NACK at 404) for a new transmission(s) at resource(s) 420.

In some aspects, the extended first sidelink DRX (e.g., SL DRX1) active time or state may overlap with the second sidelink DRX (e.g., SL DRX2). In this case, the receiving UE may decide to switch or not switch to the active receive beam for monitoring the traffic associated with the second sidelink DRX (e.g., switching from RxBeam 1 to RxBeam2 for monitoring transmissions from the second Tx UE), for example, based on QoS requirements (e.g., priority or latency) respectively associated to the traffics with the first Tx UE and the second Tx UE (e.g., switching to the active receive beam for high priority or low latency traffics). The receiving UE may monitor SCIs with resource reservations transmitted from other UEs (e.g. transmissions with messages 406 and 416) using an active receive beam (e.g., active receive beam RxBeam1 during the active time of SL DRX1 (extended or not) or active receive beam RxBeam2 during the active time of SL DRX2 (extended or not) and transmit collision indication(s) using a transmit beam corresponding to the active receive beam (e.g., using the transmit beam corresponding to the active receive beam RxBeam1 for the collision indication at 414 or using the transmit beam corresponding to the active receive beam RxBeam2 for the collision indication 408 and/or HARQ ACK/NACK 407). In this way, the sidelink RTT timer may be started at the first symbol after a collision indication based on collision indication parameters (e.g., the earliest or latest collision indication) preconfigured or configured or activated (e.g., start with SL-RTT2 running after transmitting a collision indication at 408 by the receiving UE and receiving a collision indication at 408 by the second transmitting UE or start with SL-RTT3 running after transmitting a collision indication at 414 by the receiving UE and receiving a collision indication at 414 by the first transmitting UE); or after the end of the collision detection window if no collision is detected (e.g., start with SL-RTT4 running by the receiving UE and the transmitting UE (the first and/or the second transmitting UE) after the collision detection window ending at 426). Accordingly, a sidelink HARQ retransmission timer may be started by the receiving UE or the transmitting UE respectively for monitoring or transmitting a retransmission or a new transmission at the reserved resource 420 or reselected resource (e.g., after the reserved resource 420 if the reserved resource is dropped due to the collision detected) after the sidelink RTT timer expires (e.g., after the expiration of sidelink RTT timer as the SL-RTT1, SL-RTT2, SL-RTT3 or SL-RTT4).

FIG. 4C is a simplified communication diagram according to some aspects of the present disclosure. The communication diagram in FIG. 4C illustrates an example of a transmit beam collision. FIG. 4C illustrates time and frequency resources, similar to FIGS. 4A-4B, divided into PSFCH periods 460, with PSFCH occasions 450. Similar communications to those in FIGS. 4A-4B are illustrated with the same numbers, although differences may exist, for example which UE is transmitting and/or receiving specific messages. The exact time and frequency locations of each of the messages illustrated are exemplary.

Message 402 is transmitted from a first transmitting UE to a first receiving UE and includes an SCI which reserves resources 420 for the first receiving UE in PP5. Message 402 is transmitted using a first transmit beam (e.g., TxBeam1) and received using a first receive beam (e.g., RxBeam1) paired with the first transmit beam. Reserved resource(s) 420 is scheduled to for the same transmit/receive beam pair (e.g., TxBeam1 at the first Tx UE and RxBeam1 at the first Rx UE). In some aspects, resource(s) 420 is reserved for retransmission(s) of a PSSCH message originally transmitted in message 402 in case the receiving UE fails to decode. HARQ feedback 404 may indicate a HARQ NACK associated with message 402, which may cause the first transmitting UE to use resource(s) 420 for a retransmission(s). In other aspects, resource(s) 420 may be used for a transmission by the first transmitting UE or a reception by the first receiving UE independent of the PSSCH message in message 402 (e.g., a transmission with a new TB on PSSCH).

Message 403 is transmitted from a second transmitting UE to the first receiving UE and includes an SCI which schedules resources 422 for the first receiving UE in PP5. Message 403 is transmitted by the second transmitting UE using a second transmit beam (e.g., TxBeam2) and received the first receiving UE using a corresponding second receive beam (e.g., RxBeam2) paired with the second transmit beam. Reserved resource(s) 422 is scheduled to for the same transmit/receive beam pair (e.g., TxBeam2 at the second Tx UE and RxBeam2 at the first Rx UE). In some aspects, resource(s) 422 is reserved for retransmission(s) of a PSSCH message originally transmitted in message 403 in case the receiving UE fails to decode. HARQ feedback 405 may indicate a HARQ NACK associated with message 403, which may cause the second transmitting UE to use resource(s) 422 for a retransmission(s). In other aspects, resource(s) 422 may be used for a transmission(s) by the second transmitting UE or a reception(s) by the first receiving UE independent of the PSSCH message in message 403 (e.g., a transmission with a new TB on PSSCH).

As illustrated, resource(s) 420 and resource(s) 422 occur at different times and frequencies, so that are not colliding. However, HARQ feedback 404 and 405 occur at the same time in the same PSFCH occasion, and are transmitted by the first receiving UE to two different transmitting UEs (e.g., the first and second transmitting UEs) with two different transmit beams (e.g., transmitting HARQ feedback 404 to the first transmitting UE by the first receiving UE using the transmit beam (e.g., TxBeam1′) corresponding to the first receive beam paired with the first transmitting UE (e.g., RxBeam1 at the first receiving UE paired with TxBeam1 at the first transmitting UE), and transmitting HARQ feedback 405 to the second transmitting UE by the first receiving UE using the transmit beam (e.g., TxBeam2′) corresponding to the second receive beam paired with the second transmitting UE (e.g., RxBeam2 at the first receiving UE paired with TxBeam2 at the second transmitting UE). These two beams (e.g., TxBeam1′ and TxBeam2′ at the first receiving UE) may be incompatible for a number of reasons, which may each be referred to as a transmit beam collision. For example, the first and second transmit beams (e.g., TxBeam1′ and TxBeam2′ at the first receiving UE) may be in different TCI states (e.g., with QCL type D) or spatial filters or directions, and the first receiving UE may only be capable of transmitting to one transmitting UE at in one direction at any given time using a transmit beam associated with the direction (e.g., either to the first transmitting UE using TxBeam1′ or the second transmitting UE using TxBeam2′). In some aspects, the first and second transmit beams (e.g., TxBeam1′ and TxBeam2′ at the first receiving UE) may be in the same or similar TCI state (e.g., with QCL type D) or spatial filter or direction, and the first receiving UE may only be capable of transmitting to different transmitting UEs at the same time using either transmit beam associated with the same or similar direction (e.g., using either TxBeam1′ or TxBeam2′ to both the first transmitting UE and the second transmitting UE).

The first receiving UE may communicate to the first and/or second transmitting UEs a collision indication (e.g., transmit beam collision) using the resources in the PSFCH occasion. For example, collision indication 408 may be transmitted to the first transmitting UE at the PSFCH occasion in PP3 (e.g., using TxBeam1′) and collision indication 414 may be transmitted to the second transmitting UE at the PSFCH occasion in PP3 (e.g., using TxBeam1′). In this instance since the beams are incompatible, the collision indications cannot be transmitted together at the same time (e.g., they require different beam directions), so a collision indications are sent in separate PSFCH occasions. Since the HARQ NACKS 404 and 405 are incompatible due to the transmit beam collision, they may be instead sent at HARQ feedback 412 to the first transmitting UE at the PSFCH occasion in PP3 (e.g., using TxBeam1′) and HARQ feedback 418 to the second transmitting UE at the PSFCH occasion in PP4 (e.g., using TxBeam2′) respectively.

Collision indication 408 sent in the same PSFCH occasion as a HARQ NACK 412 may be used to indicate to the first transmitting UE that the HARQ NACK is delayed from when the first transmitting UE would expect it. In other words, the collision indication 408 lets the first transmitting UE know that the HARQ NACK 412 applies to message 402 from a previous PSFCH period. Additionally or alternatively, the delayed HARQ NACK 412 and collision indication 408 at the same PSFCH also let the first transmitting UE know that the collision is a transmit beam collision for HARQ feedback. Likewise, collision indication 414 informs the second transmitting UE know that the HARQ NACK 418 applies to message 403 from a previous PSFCH period. Additionally or alternatively, the delayed HARQ NACK 418 and collision indication 414 at the same PSFCH also let the second transmitting UE know that the collision is a transmit beam collision for HARQ feedback. In some aspects, the first and/or second transmitting UEs are configured to retransmit their respective messages (i.e., messages 402 and 403) at reselected resource(s) respectively corresponding different PSFCH occasions based on the received HARQ NACK and/or collision indication.

In some aspects, a collision (e.g., transmit beam collision) is only indicated if it is determined by the receiving UE that the reserved resources will actually be used by both transmitting UEs. For example, if both messages 402 and 403 failed to decode, resulting in HARQ NACKs being transmitted, the first receiving UE may determine that both HARQ feedbacks (e.g., HARQ feedbacks 404 and 405) will be transmitted with NACKs for retransmission of the failed messages. For example, if one of messages 402 and 403 failed to decode, resulting in HARQ ACK and NACK being transmitted, the first receiving UE may determine that HARQ feedbacks (e.g., HARQ feedback 404 with an ACK and HARQ feedback 405 with a NACK) will be transmitted with an ACK for no retransmission and a NACK for retransmission (e.g., no retransmission at resource(s) 420 and retransmission(s) at resource(s) 422), or the first receiving UE may determine that a HARQ ACK (e.g., HARQ feedback 404 with an ACK) will be transmitted if a mis-transmitted or mis-received HARQ feedback is default to a NACK, or the first receiving UE may determine that a HARQ NACK (e.g., HARQ feedback 405 with a NACK) will be transmitted for NACK only HARQ feedback. For another example, if none of messages 402 and 403 failed to decode, resulting in HARQ ACKs being transmitted, the first receiving UE may determine that both HARQ feedbacks (e.g., HARQ feedbacks 404 and 405 with ACKs) will be transmitted with the ACKs for no retransmission, or the first receiving UE may determine that one HARQ feedback (e.g., HARQ feedback 404 or 405 with ACK) will be transmitted with the ACK for no retransmission.

The first receiving UE may be configured with a first sidelink discontinuous reception (DRX) associated with the first transmitting UE (e.g., SL DRX1) and a second sidelink DRX associated with the second transmitting UE (e.g., SL DRX2 where the SL DRX2 active time may or may not overlap with SL DRX1 active time). With a sidelink DRX, the receiving UE cycles between listening for transmissions and/or retransmissions and transmitting HARQ ACK/NACK feedback if enabled during a sidelink DRX active time, and waiting in a sleep state (e.g., for saving power) during a sidelink DRX inactive time. Normally a HARQ feedback with ACK/NACK would be received at the first PSFCH occasion after a message is transmitted. Because of this, the configured DRX active time may include the time until the first PSFCH occasion (e.g., a sidelink RTT timer is started at the first symbol after a HARQ feedback with a NACK at the first PSFCH occasion) and the time waiting for a retransmission (e.g., a sidelink HARQ retransmission timer is started after the sidelink RTT timer expires). However, since the transmit beam collision requires a delayed HARQ NACK (and associated collision indication) in later PSFCH periods, a sidelink RTT timer may be started by the first receiving UE or the first or second transmitting UE at the first symbol after a PSFCH occasion respectively with a transmitted or received HARQ NACK and/or a collision indication (e.g., start SL-RTT1 after the earliest PSFCH occasion with a HARQ NACK and/or a collision indication or start SL-RTT2 after the latest PSFCH occasion with a HARQ NACK and/or a collision indication, based on the collision indication parameters preconfigured or configured or activated). Consequently, the sidelink DRX active time or state may be further extended in order to monitor for the collision indication and/or the delay HARQ feedback with the delay starting time of the sidelink RTT timer (e.g., SL-RTT1 or SL-RTT1). The exact DRX active time duration and extension durations may be values that are configurable.

In some aspects, in connection with FIGS. 4A-4C, a collision indication for resource collision (as shown in FIG. 4A), receive beam collision (as shown in FIG. 4B) or transmit beam collision (as shown in FIG. 4C) may be implicitly indicated with different cyclic shift (e.g., 0 degree for resource collision, 120 degree for receive beam collision, 240 degree for transmit beam collision, or any alike. In some aspects, in connection with FIGS. 4A-4C, a collision indication for resource collision (as shown in FIG. 4A), receive beam collision (as shown in FIG. 4B) or transmit beam collision (as shown in FIG. 4C) may be implicitly indicated with different PRB groups at a PSFCH occasion for collision indication based on the collision indication parameters preconfigured or configured or activated (e.g., a first group of PRBs for resource collision, a second group of PRBs for receive beam collision, a third group of PRBs for transmit beam collision, or any alike).

In some aspects, in connection with FIGS. 4A-4C, a collision indication associated to a transmission with reserved resources may be mapped to a PRB of an earliest or latest PSFCH occasion for collision indication (e.g., based on the collision indication parameters) based on the same mapping rules for a HARQ feedback with ACK/NACK indication associated to a transmission mapped to a PRB of a PSFCH occasion for HARQ feedbacks. For example, the PRB may be mapped based on the total PRBs available for collision indication, resource allocation of the transmission (e.g., the starting PRB or subchannel in frequency and the slot in time), the ID of the UE transmitting the collision indication, or alike. Additionally or alternatively, the PRB may also be mapped with the ID of the UE receiving the collision indication (e.g., as shown in FIG. 4A collision indication 408 for the first Tx UE is mapped with the first Tx UE's ID and collision indication 410 for the second Tx UE is mapped with the second Tx UE's ID).

Additionally, or alternatively, in connection with FIGS. 4A-4C, a collision indication may be indicated in a MAC CE with or without data. The collision MAC CE carried on PSSCH may be transmitted within the collision detection window or within an upper bound for collision indication latency to one or more transmitting UEs using the transmit beams corresponding to receive beams for transmissions received or collision detection, where the MAC CE may contain a collision flag and collision type or a two-bit indication such as 00 for resource collision, 1 for receive beam collision and 10 for transmit beam collision, or alike. Additionally, the collision MAC CE may contain fields for resources overlapping in time and frequency (e.g., as shown in FIG. 4A) and associated beam information, time with receiving UE's receive beam collision (e.g., as shown in FIG. 4B) and associated beam information, or time with receiving UE's transmit beam collision (e.g., as shown in FIG. 4C) and associated beam information. In some aspects, the collision MAC CE may contain one or multiple collision indications for resource collision, receive beam collision and/or transmit beam collision, or any combined.

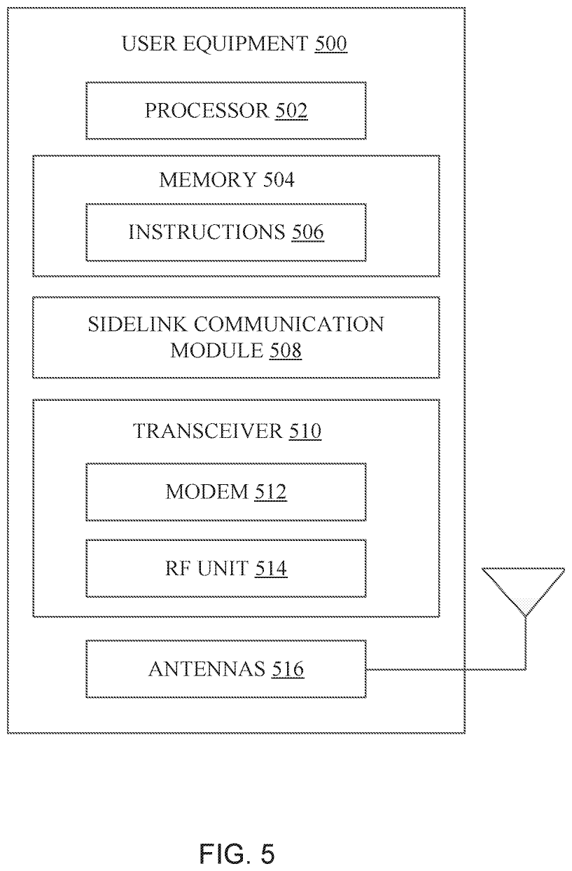

FIG. 5 is a block diagram of an exemplary UE 500 (e.g., a sidelink UE that transmits or receives collision indication messages in response to detected resource/beam collisions according to some aspects of the present disclosure. The UE 500 may be a UE 115 in the network 100 as discussed above in FIG. 1 or a UE 215 discussed above in FIG. 2. As shown, the UE 500 may include a processor 502, a memory 504, a sidelink communication module 508, a transceiver 510 including a modem subsystem 512 and a radio frequency (RF) unit 514, and one or more antennas 516. These elements may be in direct or indirect communication with each other, for example via one or more buses.

The processor 502 may include a central processing unit (CPU), a digital signal processor (DSP), an application specific integrated circuit (ASIC), a controller, a field programmable gate array (FPGA) device, another hardware device, a firmware device, or any combination thereof configured to perform the operations described herein. The processor 502 may also be implemented as a combination of computing devices, e.g., a combination of a DSP and a microprocessor, a plurality of microprocessors, one or more microprocessors in conjunction with a DSP core, or any other such configuration.

The memory 504 may include a cache memory (e.g., a cache memory of the processor 502), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In an aspect, the memory 504 includes a non-transitory computer-readable medium. The memory 504 may store, or have recorded thereon, instructions 506. The instructions 506 may include instructions that, when executed by the processor 502, cause the processor 502 to perform the operations described herein with reference to the UEs 115 in connection with aspects of the present disclosure, for example, aspects of FIGS. 1-4, and 6A-8. Instructions 506 may also be referred to as program code. The program code may be for causing a wireless communication device to perform these operations, for example by causing one or more processors (such as processor 502) to control or command the wireless communication device to do so. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The sidelink communication module 508 may be implemented via hardware, software, or combinations thereof. For example, the sidelink communication module 508 may be implemented as a processor, circuit, and/or instructions 506 stored in the memory 504 and executed by the processor 502. In some instances, the sidelink communication module 508 can be integrated within the modem subsystem 512. For example, the sidelink communication module 508 can be implemented by a combination of software components (e.g., executed by a DSP or a general processor) and hardware components (e.g., logic gates and circuitry) within the modem subsystem 512.

The sidelink communication module 508 may be used for various aspects of the present disclosure, for example, aspects of FIGS. 1-4C and 6-9.

When UE 500 is a transmitting UE, sidelink communication module 508 may be configured to schedule resources with other UEs. Sidelink communication module 508 may be configured to receive collision indications from other UEs. In response to a collision indication, sidelink communication module 508 may be configured to drop a scheduled message and/or retransmit a message which the receiving UE failed to decode.

When UE 500 is a receiving UE, sidelink communication module 508 may be configured to receive scheduling information (i.e., via SCIs) from one or more transmitting UEs using respective receive beams. Sidelink communication module 508 may be configured to determine whether there is a resource/beam conflict, and to transmit a collision indication to the transmitting UE.

As shown, the transceiver 510 may include the modem subsystem 512 and the RF unit 514. The transceiver 510 can be configured to communicate bi-directionally with other devices, such as the BSs 105. The modem subsystem 512 may be configured to modulate and/or encode the data from the memory 504 and/or the sidelink communication module 508 according to a modulation and coding scheme (MCS), e.g., a low-density parity check (LDPC) coding scheme, a turbo coding scheme, a convolutional coding scheme, a polar coding scheme, a digital beamforming scheme, etc. The RF unit 514 may be configured to process (e.g., perform analog to digital conversion or digital to analog conversion, etc.) modulated/encoded data (e.g., SCI, sidelink data, synchronization signal, SSBs, uplink data, etc.) from the modem subsystem 512 (on outbound transmissions) or of transmissions originating from another source such as a UE 115 or a BS 105. The RF unit 514 may be further configured to perform analog beamforming in conjunction with the digital beamforming. Although shown as integrated together in transceiver 510, the modem subsystem 512 and the RF unit 514 may be separate devices that are coupled together at the UE 500 to enable the UE 500 to communicate with other devices.

The RF unit 514 may provide the modulated and/or processed data, e.g. data packets (or, more generally, data messages that may contain one or more data packets and other information), to the antennas 516 for transmission to one or more other devices. The RF unit 514 may process the modulated and/or processed data and generate corresponding time-domain waveforms using SC-FDMA modulation prior to transmission via the antennas 516. In other instances, the RF unit 514 may utilize OFDM modulation to generate the time-domain waveforms. The antennas 516 may further receive data messages transmitted from other devices. The antennas 516 may provide the received data messages for processing and/or demodulation at the transceiver 510. The transceiver 510 may provide the demodulated and decoded data (e.g., sidelink configuration, SCI, sidelink data, etc.) to the sidelink communication module 508 for processing. The antennas 516 may include multiple antennas of similar or different designs in order to sustain multiple transmission links. The RF unit 514 may configure the antennas 516. In some aspects, the RF unit 514 may include various RF components, such as local oscillator (LO), analog filters, and/or mixers. The LO and the mixers can be configured based on a certain channel center frequency. The analog filters may be configured to have a certain passband depending on a channel BW. The RF components may be configured to operate at various power modes (e.g., a normal power mode, a low-power mode, power-off mode) and may be switched among the different power modes depending on transmission and/or reception requirements at the UE 500 and/or an anchor UE.

In an aspect, the UE 500 can include multiple transceivers 510 implementing different RATs (e.g., NR and LTE). In an aspect, the UE 500 can include a single transceiver 510 implementing multiple RATs (e.g., NR and LTE). In an aspect, the transceiver 510 can include various components, where different combinations of components can implement different RATs.

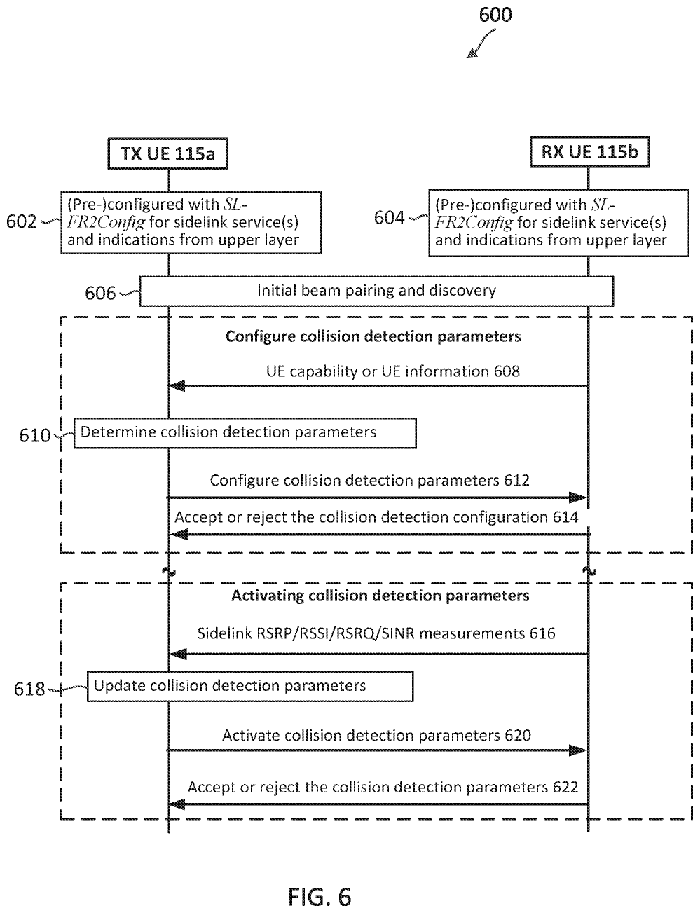

FIG. 6 is a signaling diagram of a scheme 600 for configuring collision detection parameters for sidelink communication according to some aspects of the present disclosure. The process 600 may be implemented between two UEs (e.g. UEs 115a and 115b, UEs 115j and 115k, UEs 215b1 and 215b2, or 215a1 and 215a2, or two UEs 500).

At action 602, transmitting UE 115a is pre-configured (or configured) with sidelink FR2 configuration (e.g., SL-FR2Config) for sidelink service(s) and/or indications from an upper layer (e.g., an identifier for sidelink service such as service type ID from V2X service layer or application ID from D2D ProSe application layer). The sidelink FR2 configuration may include parameters for collision detection such as enable collision detection, trigger or threshold(s) for collision detection (e.g., based on the measurement of RSSI or RSRP or RSRQ or SINR), collision detection window (e.g., start and duration or start and end point, the time gap from the last collision indication or from the end of the detection window, or alike), collision detection type (e.g., SCI based or measurement based, or both), etc., and parameters for collision indication such as collision indication type (e.g., NACK on PSFCH or MAC CE on PSSCH, indication format or mapping for different collisions such as resource collision, receive beam collision and transmit beam collision), resource(s) for indication (e.g., PSFH occasion or PSFCH period, PRBs for collision indication), time line for indication (e.g., earliest or latest within the detection window), etc.

At action 604, receiving UE 115b is pre-configured (or configured) with sidelink FR2 configuration (e.g., SL-FR2Config) for sidelink service(s) and/or indications from an upper layer (e.g., an identifier for sidelink service such as service type ID from V2X service layer or application ID from D2D ProSe application layer). The sidelink FR2 configuration may include parameters for collision detection and parameters for collision indication.

At action 606, transmitting UE 115a and receiving UE 115b perform initial beam pairing and discovery (e.g., using the destination ID for a sidelink communication).

At action 608, receiving UE 115b transmits UE capability or UE information message to transmitting UE 115a. For example, UE capability message may include UE capability with collision detection (e.g., supporting collision detection or not, type of detection if support), and UE information message may include preferred collision detection and indication parameters (e.g., collision detection window parameters, collision indication parameters, or alike).

At action 610, for resource allocation mode 2, transmitting UE 115a determines collision detection and indication parameters. In some aspects, transmitting UE 115a determines the collision detection and indication parameters based on the indicated UE capability or UE preferred collision detection and indication parameters. Additionally, or alternatively, for resource allocation mode 1, base station 105 (as shown in FIG. 1) determines collision detection and indication parameters. In some aspects, base station 105 determines the collision detection and indication parameters based on the received UE capability message (e.g., capability of collision detection and indication) or UE information message (e.g., with preferred collision detection and indication parameters).

At action 612, transmitting UE 115a configures collision detection and indication parameters on receiving UE 115b. Additionally, or alternatively, for resource allocation mode 1, base station 105 (as shown in FIG. 1) configures collision detection and indication parameters via RRC message to the transmitting UE and/or receiving UE (if under the base station's coverage).

At action 614, receiving UE 115b indicates that it accepts or rejects the received collision detection and indication configuration to transmitting UE 115a.

At action 616, receiving UE 115b transmits sidelink RSRP, RSSI, CBR, RSRQ, and/or SINR measurements to transmitting UE 115a.

At action 618, transmitting UE 115a updates collision detection and indication parameters based on the received measurements (e.g., update the thresholds or triggering condition for collision detection or resources for collision indication).

At action 620, transmitting UE 115a activates collision detection and indication parameters to receiving UE 115b.

At action 622, receiving UE 115b indicates that it accepts or rejects the activation of collision detection and indication parameters.

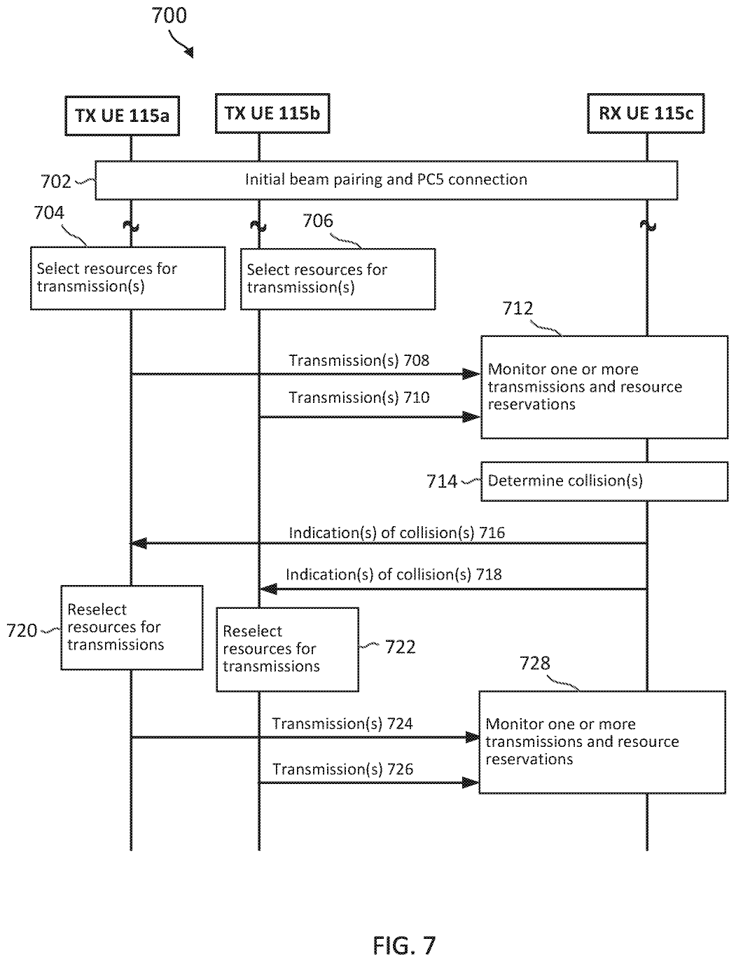

FIG. 7 is a signaling diagram of a scheme 700 for sidelink communication with according to some aspects of the present disclosure. The process 700 may be implemented between two UEs (e.g. UEs 115a and 115b, UEs 115j and 115k, UEs 215b1 and 215b2, or 215a1 and 215a2, or two UEs 500).

At action 702, initial beam pairing and PC5 connection is performed between transmitting UEs 115a and 115b and receiving UE 115c.

At action 704, transmitting UE 115a selects resources for transmission(s). The transmitting UE 115a may sense and select one or more resources for one or more transmissions to a receiving UE, where the one or more transmissions may be associated with same or different PSFCH occasions for HARQ feedback and/or collision indication (e.g., like HARQ NACK), where the sensing is by using a receive beam corresponding a transmit beam (e.g., TxBeam1) which is paired with the receiving UE 115c. The transmitting UE 115a may also sense and select one or more transmissions to each of multiple receiving UEs 115c, where the one or more transmissions may be associated with one or more of multiple PSFCH occasions (e.g., respectively associated with multiple transmitting beams which are paired with the multiple receiving UEs so that to avoid transmit beam collision or receive beam collision for transmitting or receiving the HARQ feedbacks and/or collision indications) respectively for the multiple receiving UEs' HARQ feedbacks and/or collision indications (e.g., one PSFCH occasion is associated to one receiving UE), where the sensing is by using multiple receiving beams corresponding to multiple transmitting beams which are paired with the multiple receiving UEs respectively.

At action 706, similarly, transmitting UE 115b selects resources for transmission(s) to receiving UE 115c. The transmitting UE 115b may sense and select one or more resources by using a receive beam corresponding a transmit beam (e.g., TxBeam2) which is paired with the receiving UE 115c

At action 708, transmitting UE 115a sends transmissions to receiving UE 115c (e.g., message 402 in FIGS. 4A-4C) at the selected resources using the transmit beam paired with the receiving UE 115c (e.g., TxBeam1) or sends transmissions to each of multiple receiving UEs 115c at the selected resources using multiple transmit beams paired with the multiple receiving UEs respectively. The one or more receiving UEs may monitor and decode the one or more transmissions, and then monitor and decode SCIs with resource reservations from other UEs and collect measurement of the SCIs (e.g., RSSI, RSRP, RSRQ or SINR measurement) using respectively one or more receive beams paired with one or more transmit beams of transmitting UE 115a. For example, for two SCIs indicating conflicting resources, if the RSSI, RSRP, RSRQ or SINC measurement of one SCI is above a threshold and the RSSI, RSRP, RSRQ or SINR measurement of the other SCI is below a threshold, the collision of reserved resources may be ignored and thus no collision is indicated).

At action 710, similarly, transmitting UE 115b sends transmissions to receiving UE 115c (e.g., message 403 or 406 in FIGS. 4A-4C) at the selected resources using the transmit beam (e.g., TxBeam2) paired with the receiving UE 115c.

At action 712, receiving UE 115c monitors one or more transmissions (e.g., transmissions 708 and 710) and resource reservations.

At action 714, receiving US 115c determines if there are collisions. For example, collisions in time/frequency resources, receive beam collisions, and/or transmit beam collisions as described at least in FIGS. 4A-4C.

At action 716, receiving UE 115c transmits indication(s) of collision(s) and/or HARQ feeback(s) if enabled to transmitting UE 115a (e.g., collision indication 408 or 414 in FIGS. 4A-4C), using the transmitting beam corresponding to the receiving beam (e.g., RxBeam1) paired with transmitting UE 115a.

At action 718, receiving UE 115c transmits indication(s) of collision(s) and/or HARQ feeback(s) if enabled to transmitting UE 115b (e.g., collision indication 410 or 414 in FIGS. 4A-4C).

At action 720, transmitting UE 115a reselects resources for transmissions. For example, transmitting UE 115a may drop a message scheduled for a collided resource and/or may retransmit a message in response to the collision indication as described at least in FIGS. 4A-4C.

At action 722, transmitting UE 115b reselects resources for transmissions. For example, transmitting UE 115b may drop a message scheduled for a collided resource and/or may retransmit a message in response to the collision indication as described at least in FIGS. 4A-4C.

At action 724, transmitting UE 115a sends a transmission as reselected at action 720 to receiving UE 115c.

At action 726, transmitting UE 115b sends a transmission as reselected at action 722 to receiving UE 115c.

At action 728, receiving UE 115c monitors one or more transmissions (e.g., transmissions 724 and 726) and resource reservations.

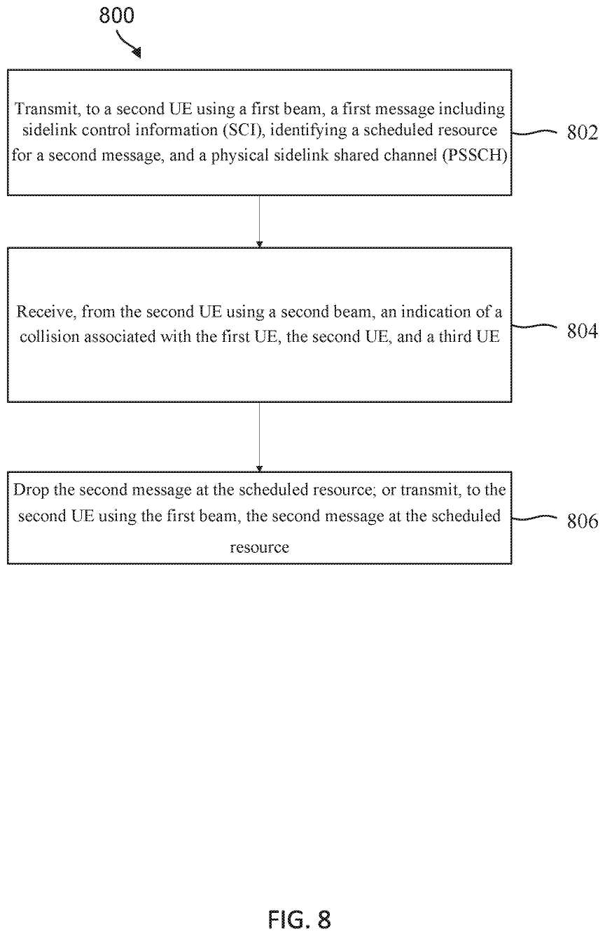

FIG. 8 is a flow diagram 800 of a method of sidelink communication according to some aspects of the present disclosure. Aspects of the method 800 can be executed by a computing device (e.g., a processor, processing circuit, and/or other suitable component) of a wireless communication device or other suitable means for performing the steps. For example, between two UEs such as UEs 115a and 115b, UEs 115j and 115k, UEs 215b1 and 215 b2, or 215at and 215a2, or two UE 500s. Aspects of method 800 may utilize one or more components, such as the processor 502, the memory 504, the sidelink communication module 508, the transceiver 510, the modem 512, and the one or more antennas 516, to execute the steps of method 800. As illustrated, the method 800 includes a number of enumerated steps, but aspects of the method 800 may include additional steps before, after, and in between the enumerated steps. In some aspects, one or more of the enumerated steps may be omitted or performed in a different order.

At block 802, a first UE transmits, to a second UE using a first beam, a first message including sidelink control information (SCI) identifying a scheduled resource for a second message and a physical sidelink shared channel (PSSCH). In some aspects, the first UE receives a HARQ NACK from the second UE associated with the first message.

At block 804, the first UE receives, from the second UE using a second beam, an indication of a collision associated with the first UE, the second UE, and a third UE. The collision may be a time and frequency resource collision associated with the scheduled resource for the second message. The collision may also be a receive beam collision associated with the scheduled resource for the second message. The collision may also be a transmit beam collision associated with a HARQ NACK. In some aspects, the indication is received in a PSFCH message. In other aspects, the indication is received in a MAC-CE message. In yet further aspects, a DRX active time for the first UE is extended for a predetermined time in response to transmitting the PSSCH message so that it may monitor for the indication.

At block 806, the first UE drops the second message at the scheduled resource; or transmits, to the second UE using the first beam, the second message at the scheduled resource. In some aspects, the first UE drops the second message in response to the indication. In other aspects, the first UE retransmits the PSSCH message with the scheduled resource in response to the indication.

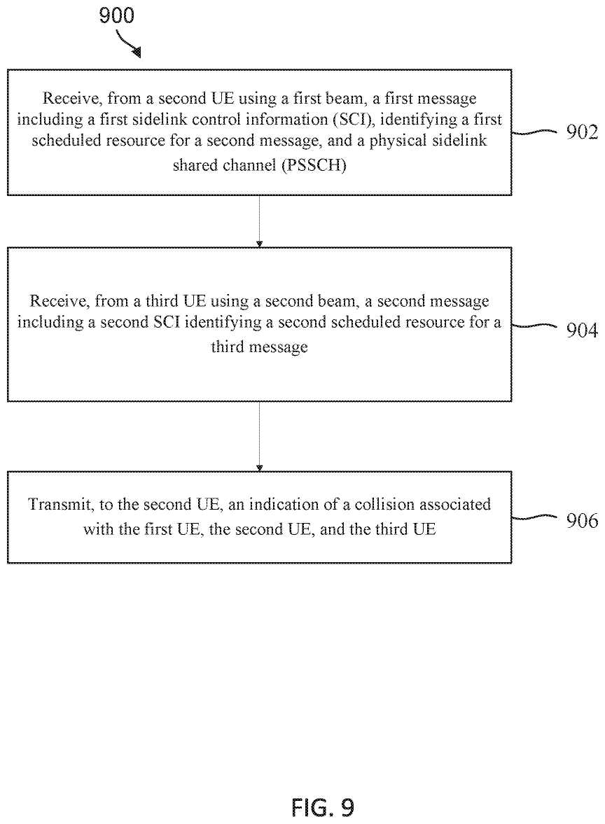

FIG. 9 is a flow diagram 900 of a method of sidelink communication according to some aspects of the present disclosure. Aspects of the method 900 can be executed by a computing device (e.g., a processor, processing circuit, and/or other suitable component) of a wireless communication device or other suitable means for performing the steps. For example, between two UEs such as UEs 115a and 115b, UEs 115j and 115k, UEs 215b1 and 215 b2, or 215at and 215a2, or two UE 500s. Aspects of method 900 may utilize one or more components, such as the processor 502, the memory 504, the sidelink communication module 508, the transceiver 510, the modem 512, and the one or more antennas 516, to execute the steps of method 900. As illustrated, the method 900 includes a number of enumerated steps, but aspects of the method 900 may include additional steps before, after, and in between the enumerated steps. In some aspects, one or more of the enumerated steps may be omitted or performed in a different order.

FIG. 9 is a flow diagram of a method of sidelink communication according to some aspects of the present disclosure. Aspects of the method 900 can be executed by a computing device (e.g., a processor, processing circuit, and/or other suitable component) of a wireless communication device or other suitable means for performing the steps. For example, between two UEs such as UEs 115a and 115b, UEs 115j and 115k, UEs 215b1 and 215 b2, or 215at and 215a2, or two UE 500s. Aspects of method 900 may utilize one or more components, such as the processor 502, the memory 504, the sidelink communication module 508, the transceiver 510, the modem 512, and the one or more antennas 516, to execute the steps of method 900. As illustrated, the method 900 includes a number of enumerated steps, but aspects of the method 900 may include additional steps before, after, and in between the enumerated steps. In some aspects, one or more of the enumerated steps may be omitted or performed in a different order.

At block 902, a first UE receives, from a second UE using a first beam, a first message including a first sidelink control information (SCI) identifying a first scheduled resource for a second message and a physical sidelink shared channel (PSSCH). In some aspects, the first UE transmits a HARQ feedback in response to the received first message. If the message fails to decode, it may transmits a HARQ NACK, and if it succeeds it may transmit a HARQ ACK.

At block 904, the first UE receives, from a third UE using a second beam, a second message including a second SCI identifying a second scheduled resource for a third message. In some aspects, the second SCI includes scheduling information for a reception by the first UE. In other aspects, the second SCI includes scheduling information for a reception by a fourth UE.

At block 906, the first UE transmits, to the second UE, an indication of a collision associated with the first UE, the second UE, and the third UE. The indication may be transmitted based on a priority order associated with the first SCI and the second SCI. The collision may be a time and frequency resource collision associated with the scheduled resource for the second message. The collision may also be a receive beam collision associated with the scheduled resource for the second message. The collision may also be a transmit beam collision associated with a HARQ NACK. The indication may be transmitted in a PSFCH or MAC-CE message.

Further aspects of the present disclosure include the following:

Aspect 1. A method of wireless communication performed by a first user equipment (UE), the method comprising:
transmitting, to a second UE using a first transmit beam, a first message including sidelink control information (SCI) identifying a scheduled resource for a second message and a physical sidelink shared channel (PSSCH);
receiving, from the second UE using a first receive beam corresponding with the first transmit beam, an indication of a collision associated with the first UE, the second UE, and a third UE; and
performing an action in response to the indication, wherein the action includes at least one of:
   dropping the second message at the scheduled resource; or
   transmitting, to the second UE using the first transmit beam, the second message at the scheduled resource.

Aspect 2. The method of aspect 1, further comprising:
receiving, from the second UE using the first receive beam, a hybrid automatic repeat request (HARQ) negative acknowledgment (NACK) associated with the first message.

Aspect 3. The method of any of aspects 1-2, wherein the indication is received in a physical sidelink feedback channel (PSFCH) message.

Aspect 4. The method of any of aspects 1-2, wherein the indication is received in a media access control-control element (MAC-CE) message.

Aspect 5. The method of any of aspects 1-4, further comprising:
extending a sidelink discontinuous reception (DRX) active time for a predetermined time for monitoring the indication, wherein the predetermined time ends before the scheduled resource for the second message.

Aspect 6. The method of any of aspects 1-5, wherein the action is dropping the second message at the scheduled resource.

Aspect 7. The method of any of aspects 1-6, wherein the collision is a time and frequency resource collision associated with the scheduled resource for the second message.

Aspect 8. The method of any of aspects 1-6, wherein the collision is a receive beam collision associated with the scheduled resource for the second message.

Aspect 9. The method of any of aspects 1-6, wherein the collision is a transmit beam collision associated with a hybrid automatic repeat request (HARQ) feedback.

Aspect 10. The method of any of aspects 1-5, wherein the action is transmitting, to the second UE using the first transmit beam, the second message at the scheduled resource.

Aspect 11. A method of wireless communication performed by a first user equipment (UE), the method comprising:
receiving, from a second UE using a first receive beam, a first message including a first sidelink control information (SCI) identifying a first scheduled resource for a second message and a physical sidelink shared channel (PSSCH);
receiving, from a third UE using a second receive beam, a second message including a second SCI identifying a second scheduled resource for a third message; and
transmitting, to the second UE using a first transmit beam corresponding with the first receive beam, an indication of a collision associated with the first UE, the second UE, and the third UE.

Aspect 12. The method of aspect 11, further comprising:
transmitting, to the second UE using the first transmit beam, a hybrid automatic repeat request (HARQ) negative acknowledgment (NACK) associated with the first message.

Aspect 13. The method of any of aspects 11-12, wherein the transmitting the indication comprises transmitting the indication in a physical sidelink feedback channel (PSFCH) message.

Aspect 14. The method of any of aspects 11-12, wherein the transmitting the indication comprises transmitting the indication in a media access control-control element (MAC-CE) message.

Aspect 15. The method of any of aspects 11-14, further comprising:
extending a sidelink discontinuous reception (DRX) active time for a predetermined time for detecting and indicating the collision, wherein the predetermined time ends before the scheduled resource for the second message.

Aspect 16. The method of any of aspects 11-15, wherein the second SCI includes scheduling information for a reception by the first UE.

Aspect 17. The method of any of aspects 11-15, wherein the second SCI includes scheduling information for a reception by a fourth UE.

Aspect 18. The method of any of aspects 11-17, wherein the collision is a time and frequency resource collision based on the first scheduled resource and the second scheduled resource at least partially overlapping in time and at least partially overlapping in frequency.

Aspect 19. The method of any of aspects 11-17, wherein the collision is a receive beam collision based on the first scheduled resource and the second scheduled resource at least partially overlapping in time and being associated with different receive beams.

Aspect 20. The method of any of aspects 11-17, wherein the collision is a transmit beam collision associated with a first hybrid automatic repeat request (HARQ) feedback and a second HARQ feedback at least partially overlapping in time and being associated with different transmit beams.

Aspect 21. The method of any of aspects 11-20, wherein the transmitting the indication is based on a priority order associated with the first SCI and the second SCI.

Aspect 22. A first user equipment (UE), comprising:
a memory, a transceiver, and at least one processor coupled to the memory and the transceiver, wherein the memory stores instructions that are executable by the at least one processor, individually or in any combination, to cause the first UE to:
   transmit, to a second UE using a first transmit beam, a first message including sidelink control information (SCI) identifying a scheduled resource for a second message and a physical sidelink shared channel (PSSCH);
   receive, from the second UE using a first receive beam corresponding with the first transmit beam, an indication of a collision associated with the first UE, the second UE, and a third UE; and
   perform an action in response to the indication, wherein the action includes at least one of:
      dropping the second message at the scheduled resource; or
      re-transmitting, to the second UE using the first transmit beam, the second message at the scheduled resource.

Aspect 23. A first user equipment (UE), comprising:
a memory, a transceiver, and at least one processor coupled to the memory and the transceiver, wherein the memory stores instructions that are executable by the at least one processor, individually or in any combination, to cause the first UE to:
receive, from a second UE using a first receive beam, a first message including a first sidelink control information (SCI) identifying a first scheduled resource for a second message and a physical sidelink shared channel (PSSCH);
   receive, from a third UE using a second receive beam, a second message including a second SCI identifying a second scheduled resource for a third message; and
   transmit, to the second UE using a first transmit beam corresponding with the first receive beam, an indication of a collision associated with the first UE, the second UE, and the third UE.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of [at least one of A, B, or C] means A or B or C or AB or AC or BC or ABC (i.e., A and B and C).

As those of some skill in this art will by now appreciate and depending on the particular application at hand, many modifications, substitutions and variations can be made in and to the materials, apparatus, configurations and methods of use of the devices of the present disclosure without departing from the spirit and scope thereof. In light of this, the scope of the present disclosure should not be limited to that of the particular embodiments illustrated and described herein, as they are merely by way of some examples thereof, but rather, should be fully commensurate with that of the claims appended hereafter and their functional equivalents.

What is claimed is:

1. A first user equipment (UE), comprising:
a memory, a transceiver, and at least one processor coupled to the memory and the transceiver, wherein the memory stores instructions that are executable by the at least one processor, individually or in any combination, to cause the first UE to:
transmit, to a second UE using a first transmit beam, a first message including sidelink control information (SCI) identifying a scheduled resource for a second message and a physical sidelink shared channel (PSSCH);
receive, from the second UE using a first receive beam corresponding with the first transmit beam, an indication of a collision associated with the first UE, the second UE, and a third UE; and
perform an action in response to the indication, wherein the action includes at least one of:
dropping the second message at the scheduled resource; or
transmitting, to the second UE using the first transmit beam, the second message at the scheduled resource.

2. The first UE of claim 1, wherein the transceiver is further configured to:
receive, from the second UE using the first receive beam, a hybrid automatic repeat request (HARQ) negative acknowledgment (NACK) associated with the first message.

3. The first UE of claim 1, wherein the indication is received in a physical sidelink feedback channel (PSFCH) message.

4. The first UE of claim 1, wherein the indication is received in a media access control-control element (MAC-CE) message.

5. The first UE of claim 1, wherein the transceiver is further configured to:
extend a sidelink discontinuous reception (DRX) active time for a predetermined time for monitoring the indication, wherein the predetermined time ends before the scheduled resource for the second message.

6. The first UE of claim 1, wherein the action is dropping the second message at the scheduled resource.

7. The first UE of claim 1, wherein the collision is a time and frequency resource collision associated with the scheduled resource for the second message.

8. The first UE of claim 1, wherein the collision is a receive beam collision associated with the scheduled resource for the second message.

9. The first UE of claim 1, wherein the collision is a transmit beam collision associated with a hybrid automatic repeat request (HARQ) feedback.

10. The first UE of claim 1, wherein the action is transmitting, to the second UE using the first transmit beam, the second message at the scheduled resource.

11. A first user equipment (UE), comprising:
a memory, a transceiver, and at least one processor coupled to the memory and the transceiver, wherein the memory stores instructions that are executable by the at least one processor, individually or in any combination, to cause the first UE to:
receive, from a second UE using a first receive beam, a first message including a first sidelink control information (SCI) identifying a first scheduled resource for a second message and a physical sidelink shared channel (PSSCH);
receive, from a third UE using a second receive beam, a second message including a second SCI identifying a second scheduled resource for a third message; and
transmit, to the second UE using a first transmit beam corresponding with the first receive beam, an indication of a collision associated with the first UE, the second UE, and the third UE.

12. The first UE of claim 11, wherein the transceiver is further configured to:
transmit, to the second UE using the first transmit beam, a hybrid automatic repeat request (HARQ) negative acknowledgment (NACK) associated with the first message.

13. The first UE of claim 11, wherein the transmitting the indication comprises transmitting the indication in a physical sidelink feedback channel (PSFCH) message.

14. The first UE of claim 11, wherein the transmitting the indication comprises transmitting the indication in a media access control-control element (MAC-CE) message.

15. The first UE of claim 11, wherein the transceiver is further configured to:
extend a sidelink discontinuous reception (DRX) active time for a predetermined for detecting and indicating the collision, wherein the predetermined time ends before the scheduled resource for the second message.

16. The first UE of claim 11, wherein the second SCI includes scheduling information for a transmission by the first UE.

17. The first UE of claim 11, wherein the second SCI includes scheduling information for a transmission by a fourth UE.

18. The first UE of claim 11, wherein the collision is a time and frequency resource collision based on the first scheduled resource and the second scheduled resource at least partially overlapping in time and at least partially overlapping in frequency.

19. The first UE of claim 11, wherein the collision is a receive beam collision based on the first scheduled resource and the second scheduled resource at least partially overlapping in time and being associated with different receive beams.

20. The first UE of claim 11, wherein the collision is a transmit beam collision associated with a first hybrid automatic repeat request (HARQ) feedback and a second HARQ feedback at least partially overlapping in time and being associated with different transmit beams.
